(19) United States
(12) Patent Application Publication
(10) Pub. No.: US 2026/0292253 A1
(43) Pub. Date: Sep. 24, 2026

(54) REGION-BASED SUPPLEMENTAL ENHANCEMENT INFORMATION MESSAGES

(71) Applicant: QUALCOMM Incorporated, San Diego, CA (US)

(72) Inventor: Yong He, San Diego, CA (US)

(21) Appl. No.: 19/468,404

(22) Filed: Feb. 3, 2026

Related U.S. Application Data
(60) Provisional application No. 63/773,893, filed on Mar. 18, 2025.

(51) Int. Cl. H04N 19/61; H04N 19/174; H04N 19/44

(52) U.S. Cl. CPC H04N 19/61; H04N 19/174; H04N 19/44

(57) ABSTRACT

A method of processing video data, the method comprising: obtaining a bitstream that includes encoded video data, the bitstream further including an Object Mask Information (OMI) Supplemental Enhancement Information (SEI) message that provides object mask information associated with a primary layer in which the OMI SEI message is present; and performing a bitstream conformance test on the bitstream that determines whether the bitstream complies with one or more constraints, wherein the one or more constraints include a requirement that, for each first OMI mask identifier in the OMI SEI message, there is no second OMI mask identifier in the OMI SEI message that is associated with a same object mask auxiliary layer as the first OMI mask identifier and that has a same value as the first OMI mask identifier.

This application claims the benefit of U.S. Provisional Patent Application 63/773,893, filed Mar. 18, 2025, the entire content of which is incorporated herein by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) that was developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for generating Supplemental Enhancement Information (SEI) messages and testing bitstreams containing the SEI messages for conformance with one or more constraints. As described herein, there are a number of problems associated with SEI messages as currently defined. These problems may include a lack of constraint on identifiers of source or target regions in object-based or region-based SEI messages, unclear coverage constraint of source objects or regions, target region position ranges being specified so that a region may be out of a target picture boundary, lack of constraint on SEI message order for region-based SEI messages associated with an SEI processing order (SPO) SEI message, empty objects or regions, and lack of signaling of complexity information. A video decoder may be unable to decode a bitstream having such problems. This may lead to crashes, interrupted playback, degraded playback, or other negative consequences. The techniques of this disclosure may address these problems. As described herein, various constraints and syntax elements are described that address these problems. In this way, the negative consequences can be avoided.

Specifically, techniques of this disclosure enforce uniqueness requirements for identifiers within Object Mask Information (OMI) and Packed Region Information (PRI) SEI messages. For an OMI SEI message, a bitstream conformance test verifies that no two mask identifiers associated with a single object mask auxiliary layer share the same value. Similarly, regarding PRI SEI messages, the techniques mandate that each region identifier remains unique across the defined regions, preventing ambiguity in region referencing.

Further constraints ensure the validity of spatial definitions for regions and objects. The disclosed techniques require that rectangular regions defined in PRI SEI messages reside entirely within the boundaries of the coded picture. Conformance tests verify that the horizontal and vertical coordinates of a top-left sample fall within the valid range of luma samples and that the defined width and height do not extend beyond the maximum picture dimensions. Additionally, for OMI SEI messages, the techniques enforce a coverage constraint requiring that at least one sample in a cropped object mask picture associated with the specified mask identifier, thereby preventing the signaling of empty or invalid masks.

To facilitate correct processing dependencies, this disclosure establishes mandatory ordering rules for SEI messages linked to an SEI Processing Order (SPO) message. For example, the techniques require a Scalability Dimension Information (SDI) SEI message containing object mask auxiliary identifiers to precede an associated OMI SEI message in decoding order. Furthermore, the techniques enhance decoder resource management by explicitly signaling complexity information. The SPO SEI message includes syntax elements indicating the processing complexity for mandatory stages and specific sub-chains, enabling a video decoder to determine processing feasibility before attempting to decode the content.

In one example, this disclosure describes a method of processing video data, the method comprising: obtaining a bitstream that includes encoded video data, the bitstream further including an OMI SEI message that provides object mask information associated with a primary layer in which the OMI SEI message is present; and performing a bitstream conformance test on the bitstream that determines whether the bitstream complies with one or more constraints, wherein the one or more constraints include a requirement that, for each first OMI mask identifier in the OMI SEI message, there is no second OMI mask identifier in the OMI SEI message that is associated with a same object mask auxiliary layer as the first OMI mask identifier and that has a same value as the first OMI mask identifier.

In another example, this disclosure describes a method of processing video data, the method comprising: generating a bitstream that includes encoded video data such that the bitstream conforms to one or more constraints, the bitstream further including an OMI SEI message that provides object mask information associated with a primary layer in which the OMI SEI message is present, wherein the one or more constraints include a requirement that, for each first OMI mask identifier in the OMI SEI message, there is no second OMI mask identifier in the OMI SEI message that is associated with a same object mask auxiliary layer as the first OMI mask identifier and that has a same value as the first OMI mask identifier.

In another example, this disclosure describes a method of processing video data, the method comprising: obtaining a bitstream that includes encoded video data, the bitstream further including a Packed Region Information (PRI) SEI message that provides packed region information regarding rectangular regions packed within a coded picture of the video data; and performing a bitstream conformance test on the bitstream that determines whether the bitstream complies with one or more constraints, wherein the one or more constraints include a requirement that, for each first PRI region identifier in the PRI SEI message, there is no second PRI region identifier in the PRI SEI message that has a same value as the first PRI region identifier.

In another example, this disclosure describes a method of processing video data, the method comprising: generating a bitstream that includes encoded video data such that the bitstream conforms to one or more constraints, the bitstream further including a PRI SEI message that provides packed region information regarding rectangular regions packed within a coded picture of the video data, wherein the one or more constraints include a requirement that, for each first PRI region identifier in the PRI SEI message, there is no second PRI region identifier in the PRI SEI message that has a same value as the first PRI region identifier.

In another example, this disclosure describes a method of processing video data, the method comprising: obtaining a bitstream that includes encoded video data, the bitstream further including an Object Mask Information (OMI) SEI message that provides object mask information associated with a primary layer in which the OMI SEI message is present; and performing a bitstream conformance test on the bitstream that determines whether the bitstream complies with one or more constraints, wherein the one or more constraints include a requirement that there is at least one sample at a first location in a cropped object mask picture in an auxiliary layer associated with the primary layer is associated with an object mask with a mask identifier associated with the auxiliary layer.

In another example, this disclosure describes a method of processing video data, the method comprising: generating a bitstream that includes encoded video data such that the bitstream conforms to one or more constraints, the bitstream further including an OMI SEI message that provides object mask information associated with a primary layer in which the OMI SEI message is present, wherein the one or more constraints include a requirement that there is at least one sample at a first location in a cropped object mask picture in an auxiliary layer associated with the primary layer is associated with an object mask with a mask identifier associated with the auxiliary layer.

In another example, this disclosure describes a method of processing video data, the method comprising: obtaining a bitstream that includes encoded video data, the bitstream further including a PRI SEI message that provides packed region information regarding rectangular regions packed within a coded picture of the video data; and performing a bitstream conformance test on the bitstream that determines whether the bitstream complies with one or more constraints, wherein the one or more constraints include a requirement that at least one of: a horizontal position of a top left sample of a region is in a range of 0 to a width of a picture in luma samples, that a vertical position of the top left sample of the region is in a range of 0 to a height of the picture in luma samples, that a width of the region is in a range of 1 to the width of the picture in luma samples, that a height of the region is in a range of 1 to the height of the picture in luma samples, the horizontal position of the top left sample of the region plus a width of the region shall be less than or equal to a maximum width of the picture, or the vertical position of the top left sample of the region plus a height of the region shall be less than or equal to a maximum height of the picture.

In another example, this disclosure describes a method of processing video data, the method comprising: generating a bitstream that includes encoded video data such that the bitstream conforms to one or more constraints, the bitstream further including a PRI SEI message that provides packed region information regarding rectangular regions packed within a coded picture of the video data, wherein the one or more constraints include a requirement that at least one of: a horizontal position of a top left sample of a region is in a range of 0 to a width of a picture in luma samples, that a vertical position of the top left sample of the region is in a range of 0 to a height of the picture in luma samples, that a width of the region is in a range of 1 to the width of the picture in luma samples, that a height of the region is in a range of 1 to the height of the picture in luma samples, the horizontal position of the top left sample of the region plus a width of the region shall be less than or equal to a maximum width of the picture, or the vertical position of the top left sample of the region plus a height of the region shall be less than or equal to a maximum height of the picture.

In another example, this disclosure describes a method of processing video data, the method comprising: obtaining a bitstream that includes encoded video data, the bitstream further including a Film Grain Regions Characteristics (FGRC) SEI message that provides a decoder with a parameterized model for a film grain synthesis process; and performing a bitstream conformance test on the bitstream that determines whether the bitstream complies with one or more constraints, wherein the one or more constraints include: (i) a requirement that film grain regions specified by the FGRC SEI message do not overlap, or (ii) a requirement that different film grain simulation models do not apply to a single one of the film grain regions specified by the FGRC SEI message.

In another example, this disclosure describes a method of processing video data, the method comprising: generating a bitstream that includes encoded video data such that the bitstream conforms to one or more constraints, the bitstream further including a FGRC SEI message that provides a decoder with a parameterized model for a film grain synthesis process, wherein the one or more constraints include: (i) a requirement that film grain regions specified by the FGRC SEI message do not overlap, or (ii) a requirement that different film grain simulation models do not apply to a single one of the film grain regions specified by the FGRC SEI message.

In another example, this disclosure describes a method of processing video data, the method comprising: obtaining a bitstream that includes encoded video data, the bitstream further including a Packed Region Information (PRI) SEI message that provides packed region information regarding rectangular regions packed within a coded picture of the video data; and performing a bitstream conformance test on the bitstream that determines whether the bitstream complies with one or more constraints, wherein the one or more constraints include a requirement that a value of a first syntax element specifying an x component of a top left sample position of a region in a reconstructed target picture shall be in a range of 0 to a value of a second syntax element specifying a target picture width minus 1, and a value of a third syntax element specifying a y component of the top left sample position of the region shall be in a range of 0 to a value of a fourth syntax element specifying a target picture height minus 1.

In another example, this disclosure describes a method of processing video data, the method comprising: generating a bitstream that includes encoded video data such that the bitstream conforms to one or more constraints, the bitstream further including a Packed Region Information (PRI) SEI message that provides packed region information regarding rectangular regions packed within a coded picture of the video data, wherein the one or more constraints include a requirement that a value of a first syntax element specifying an x component of a top left sample position of a region in a reconstructed target picture shall be in a range of 0 to a value of a second syntax element specifying a target picture width minus 1, and a value of a third syntax element specifying a y component of the top left sample position of the region shall be in a range of 0 to a value of a fourth syntax element specifying a target picture height minus 1.

In another example, this disclosure describes a method of processing video data, the method comprising: obtaining a bitstream that includes encoded video data, the bitstream further including: an Object Mask Information (OMI) SEI message that provides object mask information associated with a primary layer in which the OMI SEI message is present; and a SEI processing order (SPO) SEI message that carries information indicating a processing order, as determined by an encoder, for a group of types of SEI messages, wherein the SPO SEI message includes a first syntax element having a first value, wherein the first value plus 2 indicates a number of types of SEI messages for which the processing order is indicated in the SPO SEI message, the SPO SEI message includes second syntax elements indicating payload type values for the SEI messages, and the SPO SEI message includes two or more third syntax elements indicating SEI processing orders; and performing a bitstream conformance test on the bitstream that determines whether the bitstream complies with one or more constraints, wherein the one or more constraints include one or more of: a first requirement that, for any two different integer values of m and n in a range of 0 to the first value plus 1, when a first second syntax element of the second syntax elements having index m indicates the OMI SEI message and a second second syntax element of the second syntax elements having index n indicates a first SDI SEI message with a first SDI auxiliary identifier having a value indicating an auxiliary object mask number, a first third syntax element of the third syntax elements having index m shall be greater than a second third syntax element of the third syntax elements having index n, a second requirement that, for any two different integer values of m and n in a range of 0 to the first value plus 1, when the first second syntax element having index m indicates a display overlay information (DOI) SEI message with a DOI partition type indicator syntax element equal to 1 and the second second syntax element having index n indicates a Constituent Rectangle (CR) SEI message, the first third syntax element of the third syntax elements having index m shall be greater than the second third syntax element of the third syntax elements having index n, or a third requirement that, for any two different integer values of m and n in a range of 0 to the first value plus 1, when the first second syntax element having index m indicates a FGRC SEI message and the second second syntax element having index n indicates a second SDI SEI message with a second SDI auxiliary identifier equal to 1, the first third syntax element of the third syntax elements having index m shall be greater than the second third syntax element of the third syntax elements having index n.

In another example, this disclosure describes a method of processing video data, the method comprising: generating a bitstream that includes encoded video data such that the bitstream conforms to one or more constraints, the bitstream further including an OMI SEI message that provides object mask information associated with a primary layer in which the OMI SEI message is present; and a SEI processing order (SPO) SEI message that carries information indicating a processing order, as determined by an encoder, for a group of types of SEI messages, wherein the SPO SEI message includes a first syntax element having a first value, wherein the first value plus 2 indicates a number of types of SEI messages for which the processing order is indicated in the SPO SEI message, the SPO SEI message includes second syntax elements indicating payload type values for the SEI messages, and the SPO SEI message includes two or more third syntax elements indicating SEI processing orders, wherein the one or more constraints include one or more of: a first requirement that, for any two different integer values of m and n in a range of 0 to the first value plus 1, when a first second syntax element of the second syntax elements having index m indicates the OMI SEI message and a second second syntax element of the second syntax elements having index n indicates a first SDI SEI message with a first SDI auxiliary identifier having a value indicating an auxiliary object mask number, a first third syntax element of the third syntax elements having index m shall be greater than a second third syntax element of the third syntax elements having index n, a second requirement that, for any two different integer values of m and n in a range of 0 to the first value plus 1, when the first second syntax element having index m indicates a display overlay information (DOI) SEI message with a DOI partition type indicator syntax element equal to 1 and the second second syntax element having index n indicates a Constituent Rectangle (CR) SEI message, the first third syntax element of the third syntax elements having index m shall be greater than the second third syntax element of the third syntax elements having index n, or a third requirement that, for any two different integer values of m and n in a range of 0 to the first value plus 1, when the first second syntax element having index m indicates a Film Grain Regions Characteristics (FGRC) SEI message and the second second syntax element having index n indicates a second SDI SEI message with a second SDI auxiliary identifier equal to 1, the first third syntax element of the third syntax elements having index m shall be greater than the second third syntax element of the third syntax elements having index n.

In another example, this disclosure describes a method of processing video data, the method comprising: obtaining a bitstream that includes encoded video data, the bitstream further including an OMI SEI message that provides object mask information associated with a current primary layer in which the OMI SEI message is present, the OMI SEI message including a first syntax element that indicates whether object mask information of an object mask auxiliary layer is associated with the current primary layer is updated, a second syntax element specifying a number of object masks of the object mask auxiliary layer; and performing a bitstream conformance test on the bitstream that determines whether the bitstream complies with one or more constraints, wherein the one or more constraints include one or more of: a first requirement that, when the OMI SEI message is parsed for a first time in a current coded layer video sequence (CLVS), a value of the first syntax element shall be equal to 1; or a second requirement that, when the first syntax element is parsed for the first time in the current CLVS, a value of the second syntax element shall not be equal to 0.

In another example, this disclosure describes a method of processing video data, the method comprising: generating a bitstream that includes encoded video data such that the bitstream conforms to one or more constraints, the bitstream further including an OMI SEI message that provides object mask information associated with a current primary layer in which the OMI SEI message is present, the OMI SEI message including a first syntax element that indicates whether object mask information of an object mask auxiliary layer is associated with the current primary layer is updated, a second syntax element specifying a number of object masks of the object mask auxiliary layer, wherein the one or more constraints include one or more of: a first requirement that, when the OMI SEI message is parsed for a first time in a current CLVS, a value of the first syntax element shall be equal to 1; or a second requirement that, when the first syntax element is parsed for the first time in the current CLVS, a value of the second syntax element shall not be equal to 0.

In another example, this disclosure describes a method of processing video data, the method comprising: obtaining a bitstream that includes encoded video data, the bitstream further including: a SEI processing order (SPO) SEI message that carries information indicating a processing order, as determined by an encoder, for a group of types of SEI messages, wherein the SPO SEI message includes one or more of: a first syntax element indicating whether processing order mandatory stage complexity information is present in the SPO SEI message, a second syntax element indicating whether a third syntax element is present, the third syntax element specifying a number of sub-chains indicated by the SPO SEI message, the third syntax element, a fourth syntax element indicating whether complexity information for a sub-chain is present in the SPO SEI message, or a fifth syntax element containing complexity information of the sub-chain; and processing additional SEI messages based on the processing order.

In another example, this disclosure describes a method of processing video data, the method comprising: generating a bitstream that includes encoded video data, the bitstream further including: a SPO SEI message that carries information indicating a processing order, as determined by an encoder, for a group of types of SEI messages, wherein the SPO SEI message includes one or more of: a first syntax element indicating whether processing order mandatory stage complexity information is present in the SPO SEI message, a second syntax element indicating whether a third syntax element is present, the third syntax element specifying a number of sub-chains indicated by the SPO SEI message, the third syntax element, a fourth syntax element indicating whether complexity information for a sub-chain is present in the SPO SEI message, or a fifth syntax element containing complexity information of the sub-chain.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a block diagram illustrating an example video encoder that may perform the techniques of this disclosure.

FIG. 3 is a block diagram illustrating an example video decoder that may perform the techniques of this disclosure.

FIG. 4 is a flowchart illustrating an example method for encoding a current block in accordance with the techniques of this disclosure.

FIG. 5 is a flowchart illustrating an example method for decoding a current block in accordance with the techniques of this disclosure.

FIG. 6 is a flowchart illustrating an example method of encoding video data in accordance with the techniques of this disclosure.

FIG. 7 is a flowchart illustrating an example method of processing video data in accordance with the techniques of this disclosure.

### DETAILED DESCRIPTION

In general, this disclosure describes techniques for generating Supplemental Enhancement Information (SEI) messages and testing bitstreams containing the SEI messages for conformance with one or more constraints. As described herein, there are a number of problems associated with SEI messages as currently defined. These problems may include a lack of constraint on identifiers of source or target regions in object-based or region-based SEI messages, unclear coverage constraint of source objects or regions, target region position ranges being specified so that a region may be out of a target picture boundary, lack of constraint on SEI message order for region-based SEI messages associated with an SEI processing order (SPO) SEI message, empty objects or regions, and lack of signaling of complexity information. A video decoder may be unable to decode a bitstream having such problems. This may lead to crashes, interrupted playback, degraded playback, or other negative consequences. The techniques of this disclosure may address these problems. As described herein, various constraints and syntax elements are described that address these problems. In this way, the negative consequences can be avoided.

For example, video coding systems frequently utilize SEI messages to provide metadata describing specific regions or objects within a video sequence, such as Object Mask Information (OMI) or Packed Region Information (PRI). In the context of the Object Mask Information (OMI) SEI message, an object may be any distinct entity or region of interest within a video scene, such as a person, a vehicle, or a specific background element. These objects are identified and outlined by the mask data provided in the auxiliary layer, allowing the video decoder to isolate or process the objects independently from the rest of the picture.

While OMI SEI messages and PRI SEI messages typically include syntax elements to assign identifiers to specific masks or regions, existing approaches often lack explicit constraints enforcing the uniqueness of such identifiers. Consequently, a bitstream might assign the same identifier value to multiple distinct masks or regions within a single SEI message or associated layer. This duplication creates ambiguity for a video decoder attempting to reference or update specific masks or regions, potentially leading to decoding errors, inconsistent video processing, or system crashes.

To address these technical challenges, the techniques of this disclosure introduce bitstream conformance constraints to ensure identifier uniqueness within OMI SEI messages and PRI SEI messages. In some examples, a method of processing video data includes performing a conformance test to verify that, for an OMI SEI message, no two mask identifiers associated with the same object mask auxiliary layer share the same value. Similarly, for a PRI SEI message, the techniques may enforce a requirement that each region identifier is unique among all regions specified in the message.

By establishing strict uniqueness constraints for mask identifiers and region identifiers, the disclosed techniques eliminate ambiguity in the identification of masks and regions. Validating that distinct masks and regions possess distinct identifiers allows a video decoder to reliably associate properties and updates with the correct target masks and target regions without risk of confusion or data collision. This increased robustness prevents undefined behavior during the decoding process and ensures consistent playback and rendering of region-based video features.

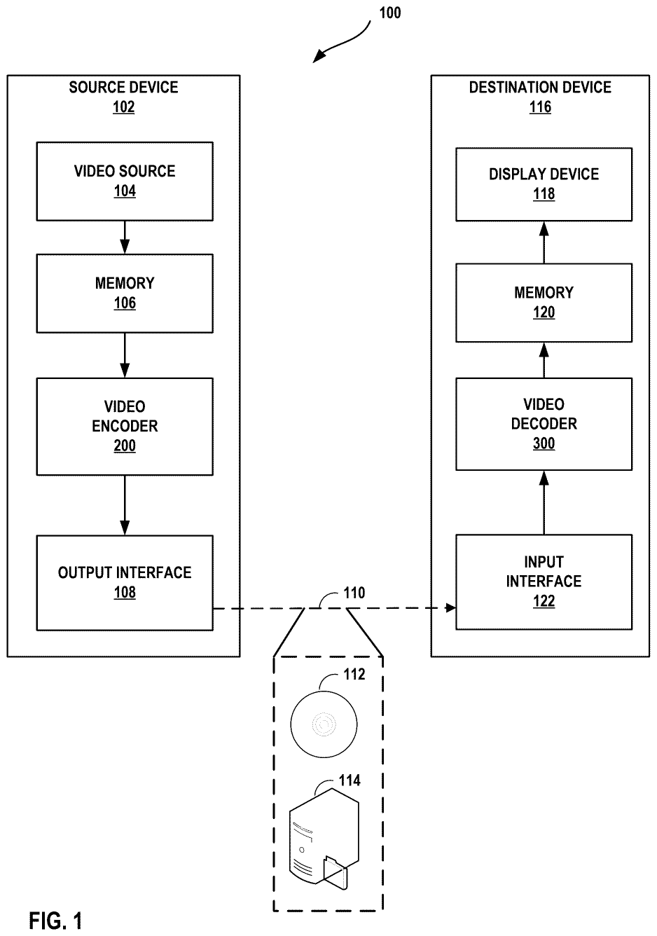

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may be or include any of a wide range of devices, such as desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques involving SEI messages. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques involving SEI messages. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder (e.g., audio codec), and may include appropriate MUX-DEMUX units, or other hardware and/or software, to handle multiplexed streams including both audio and video in a common data stream. Example audio codecs may include AAC, AC-3, AC-4, ALAC, ALS, AMBE, AMR, AMR-WB (G.722.2), AMR-WB+, aptx (various versions), ATRAC, BroadVoice (BV16, BV32), CELT, Enhanced AC-3 (E-AC-3), EVS, FLAC, G.711, G.722, G.722.1, G.722.2 (AMR-WB). G.723.1, G.726, G.728, G.729, G.729.1, GSM-FR, HE-AAC, iLBC, iSAC, LA Lyra, Monkey's Audio, MP1, MP2 (MPEG-1, 2 Audio Layer II), MP3, Musepack, Nellymoser Asao, OptimFROG, Opus, Sac, Satin, SBC, SILK, Siren 7, Speex, SVOPC, True Audio (TTA), TwinVQ, USAC, Vorbis (Ogg), WavPack, and Windows Media Aud.

Video encoder 200 and video decoder 300 each may be implemented as any of a variety of suitable encoder and/or decoder circuitry that includes a processing system, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may implement video encoder 200 and/or video decoder 300 in processing circuitry such as an integrated circuit and/or a microprocessor. Such a device may be a wireless communication device, such as a cellular telephone, or any other type of device described herein.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that involve supplemental enhancement information (SEI) messages.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of CTUs. Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to CUs.

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2. N/4×N, and N×N/4 blocks. Video encoder 200 and video decoder 300 may perform separate prediction and transform processes on each of the coding blocks.

Video encoder 200 and video decoder 300 may be configured to use quadtree partitioning, QTBT partitioning, MTT partitioning, superblock partitioning, or other partitioning structures. In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may include N×M samples, where Mis not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

Versatile supplemental enhancement information (VSEI) standard, that is ITU-T H.274 and ISO/IEC 23002-7, specifies the video usability information (VUI) and some of the SEI messages used with the VVC bitstream. The SEI mechanism enables encoders to include such metadata in the bitstream that is not required for the correct decoding of the sample values of the output pictures but can be used for various other purposes. Encoders can include any number of SEI NAL units in an access unit, and each SEI NAL unit may contain one or more SEI messages. Specifications and systems using VVC may require encoders to generate certain SEI messages or may define specific handling of particular types of received SEI messages.

In the 37th JVET meeting, additional SEI messages are added for VSEI version 4 (Draft 5), e.g., as described in JVET-AK2006-v1, Additional SEI messages for VSEI version 4 (Draft 5)) and potential SEI messages for future extension of VSEI are included in JVET-AK2032-v1, Technologies under consideration for future extensions of VSEI (version 7). VSEI version 4 and the VSEI test model under consideration (TuC) specify a number of object-based SEI messages, such as OMI SEI messages, and region-based SEI messages, such as PRI SEI messages, film grain regions characteristics (FGRC) SEI message, constituent rectangles (CR) SEI message, display overlay information (DOI) SEI message, bitdepth range information (BRI) SEI message, and display rectangles (DR) SEI message. Most object- or region-based SEI messages specify the identifying number of the object or region, the position and size of the region, and the processing of the regions.

The OMI SEI message may provide object mask information associated with a primary layer, referred to as the current primary layer, in which the SEI message is present. The object mask information may comprise data that identify and outline objects within a picture of the video data. The following tables indicates an example syntax of the OMI SEI message, as set forth in JVET-AK2006.

| | De- |
|---|---|
| | scriptor |
| object_mask_info( payloadSize ) { | |
| omi_cancel_flag | u(1) |
| if( !omi_cancel_flag ) { | |
| omi_persistence_flag | u(1) |
| omi_num_aux_pic_layer_minus1 | ue(v) |
| omi_mask_id_length_minus1 | ue(v) |
| omi_mask_sample_value_length_minus8 | ue(v) |
| omi_mask_confidence_info_present_flag | u(1) |
| if( omi_mask_confidence_info_present_flag ) | |
| omi_mask_confidence_length_minus1 | u(4) |
| omi_mask_depth_info_present_flag | u(1) |
| if( omi_mask_depth_info_present_flag ) | |
| omi_mask_depth_length_minus1 | u(4) |
| omi_mask_label_info_present_flag | u(1) |
| if( omi_mask_label_info_present_flag ) { | |
| omi_mask_label_language_present_flag | u(1) |
| if( omi_mask_label_language_present_flag ) { | |
| while( !byte_aligned( ) ) | |
| omi_bit_equal_to_zero | f(1) |
| omi_mask_label_language | st(v) |
| } | |
| } | |
| for( i = 0; i < omi_num_aux_pic_layer_minus1; i++ ) { | |
| omi_mask_pic_update_flag[ i ] | u(1) |
| if( omi_mask_pic_update_flag[ i ] ) { | |
| omi_num_mask_in_pic[ i ] | ue(v) |
| for( j = 0; j < omi_num_mask_in_pic[ i ]; j++ ) { | |
| omi_mask_id[ i ][ j ] | u(v) |
| omi_mask_id_new_object_flag [ i ][ j ] | u(1) |
| omi_aux_sample_value[ i ][ j ] | u(v) |
| omi_mask_bounding_box_present_flag[ i ][ j ] | u(1) |
| if( omi_mask_bounding_box_present_flag[ i ][ j | |
| ] ) { | |
| omi_mask_top[ i ][ j ] | u(16) |
| omi_mask_left[ i ][ j ] | u(16) |
| omi_mask_width[ i ][ j ] | u(16) |
| omi_mask_height[ i ][ j ] | u(16) |
| } | |
| if( omi_mask_confidence_info_present_flag ) | |
| omi_mask_confidence[ i ][ j ] | u(v) |
| if( omi_mask_depth_info_present_flag ) | |
| omi_mask_depth[ i ][ j ] | u(v) |
| if( omi_mask_label_info_present_flag ) { | |
| while( !byte_aligned( ) ) | |
| omi_bit_equal_to_zero | f(1) |
| omi_mask_label[ i ][ j ] | st(v) |
| } | |
| } | |
| } | |
| } | |
| } | |
| } | |

omi_mask_pic_update_flag[i] equal to 1 indicates the object mask information of the i-th object mask auxiliary layer associated with the current primary layer is updated. omi_mask_pic_update_flag[i] equal to 0 indicates there is no change to the mask information of the i-th object mask auxiliary layer associated with the current primary layer. When omi_mask_pic_update_flag[i] is equal to 0, the object mask information of the i-th object mask auxiliary layer for the current picture is inherited from the last OMI SEI message that was present in the same layer in output order which explicitly signalled the mask information of the i-th object mask auxiliary layer associated with the current primary layer.

omi_num_mask_in_pic[i] specifies the number of object masks of the i-th object mask auxiliary layer associated with the current primary layer. omi_num_mask_in_pic[i] shall be in the range of 0 to (1<< (omi_mask_id_length_minus1+1))−1, inclusive.

When the OMI SEI message is present in the current coded video sequence (CVS), a Scalability Dimension Information (SDI) SEI message is expected to also be present in the current CVS and has sdi_aux_id[i] equal to AUX_OBJECT_MASK for at least one value of i. If a CVS does not contain an SDI SEI message with sdi_aux_id[i] equal to AUX_OBJECT_MASK for at least one value of i, the OMI SEI message should be ignored. When an Access Unit (AU) contains both an SDI SEI message with sdi_aux_id[i] equal to AUX_OBJECT_MASK for at least one value of i and an OMI SEI message, the SDI SEI message shall precede the OMI SEI message in decoding order.

TABLE 15
Mapping of sdi_aux_id[i] to the type of auxiliary pictures

| sdi_aux_id[i] | Name | Type of auxiliary pictures |
|---|---|---|
| 1 | AUX_ALPHA | Alpha plane |
| 2 | AUX_DEPTH | Depth picture |
| 3 | AUX_OBJECT_MASK | Object mask picture |
| 4 . . . 127 | | Reserved |
| 128 . . . 159 | | Unspecified |
| 160 . . . 255 | | Reserved |

The PRI SEI message may provide information regarding rectangular regions packed with the coded picture. The information in the PRI SEI message may optionally be used to reconstruct a target picture from the samples of the cropped decoded picture corresponding to the regions described in this SEI message. The CR SEI message may enable composition of multiple rectangles within a coded picture in one or more layers and provides information about the rectangles, including ID, type, text description, location, and size.

An SEI processing order (SPO) SEI message may carry information indicating the preferred processing order, as determined by the encoder (i.e., the content producer), for a group of types of SEI messages that may be present in a coded layer video sequence (CLVS). The following table indicates an example syntax of the SPO SEI message, as set forth in JVET-AK2006.

| | De- |
|---|---|
| | scriptor |
| sei_processing_order( payloadSize ) { | |
| po_id | u(8) |
| po_for_human_viewing_idc | u(2) |
| po_for_machine_analysis_idc | u(2) |
| po_reserved_zero_4bits | u(4) |
| po_num_sei_messages_minus2 | u(7) |
| po_breadth_first_flag | u(1) |
| for( i = 0, i < po_num_sei_messages_minus2 + 2; i++ ) { | |
| po_sei_wrapping_flag[ i ] | u(1) |
| po_sei_importance_flag[ i ] | u(1) |
| po_sei_processing_degree_flag[ i ] | u(1) |
| po_sei_payload_type[ i ] | u(12) |
| po_sei_prefix_flag[ i ] | u(1) |
| po_sei_processing_order[ i ] | u(8) |
| } | |
| for( i = 0; i < po_num_sei_messages_minus2 + 2; i++ ) | |
| if( po_sei_prefix_flag[ i ] ) { | |
| po_num_bits_in_prefix_indication_minus1[ i ] | u(8) |
| for( j = 0; j <= | |
| po_num_bits_in_prefix_indication_minus1[ i ]; j++ ) | |
| po_sei_prefix_data_bit[ i ][ j ] | u(1) |
| while( !byte_aligned( ) ) | |
| po_byte_alignment_bit_equal_to_one /* equal to 1 | f(1) |
| */ | |
| } | |
| po_complexity_info_present_flag | u(1) |
| if( po_complexity_info_present_flag ) { | |
| po_parameter_type_idc | u(2) |
| if( po_parameter_type_idc != 2 ) | |
| po_log2_parameter_bit_length_minus3 | u(2) |
| po_num_parameters_idc | u(6) |
| po_num_kmac_operations_idc | ue(v) |
| po_total_kilobyte_size | ue(v) |
| } | |
| } | |

po_sei_importance_flag[i] affects the derivation of PoSeiList, which is the list of SEI messages that a decoding system should process for a particular picture picA, as specified below.

po_sei_processing_degree_flag[i] affects the derivation of PoSeiList as specified below.

A processing chain may contain zero or more sub-chains. A sub-chain includes such SEI message types that either all these SEI message types should be processed by a decoding system or, if the decoding system cannot interpret or does not support one or more of these SEI message types, none of the SEI message types of the sub-chain should be processed. The SEI message types that belong to a sub-chain are determined by the values of po_sei_importance_flag[i] and po_sei_processing_degree_flag[i] as specified below. Table 24 specifies the interpretation of po_sei_importance_flag[i] and po_sei processing_degree_flag[i].

TABLE 24
Interpretation of po_sei_{—}
importance_flag[i] and po_sei_{—}
processing_degree_flag[i]

| po_sei_{—} | | |
|---|---|---|
| importance_{—} | po_sei_processing_{—} | |
| flag[i] | degree_flag[i] | Interpretation |
| 0 | 0 | When the decoding system |
| | | cannot interpret or does |
| | | not support the i-th SEI |
| | | message type, it shall |
| | | ignore all data |
| | | associated with the loop |
| | | variable value of i and |
| | | exclude the i-th SEI |
| | | message type from the |
| | | processing chain |
| | | performed by the |
| | | decoding system. |
| 0 | 1 | The i-th SEI message |
| | | type ends a sub-chain. |
| 1 | 0 | The i-th SEI message |
| | | type starts a sub-chain. |
| 1 | 1 | If a sub-chain start is |
| | | indicated with index |
| | | startIdx less than i and |
| | | there is no sub-chain |
| | | end with index greater |
| | | than startIdx and less |
| | | than i, the i-th SEI |
| | | message type belongs to |
| | | a sub-chain. |
| | | Otherwise, the i-th SEI |
| | | message type is a |
| | | mandatory processing |
| | | stage. In this case, |
| | | when the decoding system |
| | | cannot interpret or does |
| | | not support the i-th SEI |
| | | message type, it should |
| | | not apply the processing |
| | | chain. |

A sub-chain is open-ended when no end of sub-chain is indicated prior to the start of the next sub-chain (if any) or the end of the processing chain, whichever is earlier in the processing order. When the decoding system cannot interpret or does not support the i-th SEI message type for which:
po_sei_importance_flag[PoSeiTypeIdx[i]]+
po_sei_processing_degree_flag[PoSeiTypeIdx[i]] is greater than or equal to 1 and the i-th SEI message type belongs to a sub-chain subChainB, the following applies:
   If subChainB is open-ended, the decoding system should not process subChainB or any of the processing stages following subChainB.
   Otherwise, the decoding system should not process subChainB.

po_sei_payload_type[i] specifies the payloadType value of the i-th type of SEI message. po_sei_processing_order[i] indicates the preferred order of processing of the i-th type of SEI message for which preferred processing order information is provided in the SPO SEI message.

po_num_kmac_operations_idc greater than 0 indicates that the maximum number of multiply-accumulate (K-MAC) operations per sample of the neural-network post-filters (NNPFs) in the processing chain identified by the sei processing order SEI message is less than or equal to po_num_kmac_operations_idc*1000. po_num_kmac_operations_idc equal to 0 indicates that the maximum number of multiply-accumulate operations of the NNPFs in the processing chain identified by the sei processing order SEI message is unknown. The value of po_num_kmac_operations_idc shall be in the range of 0 to 232-2, inclusive.

po_total_kilobyte_size greater than 0 indicates a total size in kilobytes required to store the uncompressed parameters for the NNPFs in the processing chain identified by the sei processing order SEI message. The total size in bits is a number equal to or greater than the sum of bits used to store each parameter. po_total_kilobyte_size is the total size in bits divided by 8000, rounded up. po_total_kilobyte_size equal to 0 indicates that the total size required to store the parameters for the NNPFs in the processing chain identified by the sei processing order SEI message is unknown. The value of po_total_kilobyte_size shall be in the range of 0 to 232-2, inclusive. By parsing po_num_kmac_operations_idc and po_total_kilobyte_size values, video decoder 300 can determine whether video decoder 300 has sufficient processing power and memory availability to decode and process the associated SEI messages without stalling or crashing.

A number of problems related to the current object- or region-based SEI messages design are described as follows: (1) Current object- or region-based SEI messages lack the constraint of the identifier of the source or target regions; it is problematic when two different regions share the same identifier. (2) It is unclear the coverage constraint of the source objects or regions, whether a sample at position (x, y) may belong to multiple regions, or exact one region, or may not belong to any regions. (3) The target region position range is not specified, so the region may be out of the target picture boundary. (4) Some object- or region-based SEI messages may depend on other SEI messages or influence its following SEI messages. It is beneficial to constrain the SEI message order when the region-based SEI message is associated with the SEI processing order (SPO) SEI message. (5) An SEI message, such as an OMI SEI message, may use a syntax element flag to condition the presence of the region information, and may therefore end up with an empty object or region without present constraints on the syntax element flag. (6) A processing chain in an SPO SEI message may include SEI messages marked as a mandatory stage, SEI messages marked as a sub-chain, and SEI messages marked as optional.

In the context of the SPO SEI message, a mandatory stage refers to a primary processing level (or set of SEI messages) that a video decoder must support or execute to ensure the fundamental operation of the identified SEI processing chain. A sub-chain represents a distinct, secondary sequence or group of SEI messages within the broader processing order that a decoder may process in addition to the mandatory stage, often subject to resource availability. Together, signaling complexity information for both components allows a decoder to determine processing feasibility and perform resource optimization before attempting to decode the content.

When video decoder 300 cannot support the entire processing chain, the decoder may process the mandatory stage, or the mandatory stage and one or more sub-chains. It is beneficial to signal complexity information for the mandatory stage and the sub-chains in SPO SEI message. Providing complexity information for the mandatory stage and the sub-chains enables video decoder 300 to determine if destination device 116 possesses sufficient resources to process the mandatory stage or specific sub-chains. This signaling may help video decoder 300 avoid crashes or interruptions by preventing the execution of processing chains that exceed the capabilities of destination device 116. Furthermore, explicitly signaling the complexity information enables video decoder 300 to perform power management and resource optimization. By analyzing syntax elements such as po_num_kmac_operations_idc, video decoder 300 can estimate the computational load required for the mandatory stage or sub-chains. In some examples, if the required complexity is within the maximum capabilities of destination device 116, video decoder 300 may reduce its operating frequency or voltage (e.g., via Dynamic Voltage and Frequency Scaling (DVFS)) to conserve battery life while maintaining real-time performance.

### Bitstream Conformance Requirement on the Identifier of the Objects and Regions

In accordance with a technique of this disclosure, a constraint is proposed to apply to omi_mask_id of Object Mask Information (OMI) SEI message as indicated below.
It is a requirement of bitstream conformance that when j not equal to k, the value of omi_mask_id[i][j] shall not equal to the value of omi_mask_id[i][k] in an OMI SEI message
   The syntax element omi_mask_id[i][j] may indicate the identifier of the j-th object mask of the i-th object mask auxiliary layer associated with the current primary layer.

Thus, in some examples, video encoder 200 generates a bitstream that includes encoded video data such that the bitstream conforms to one or more constraints, the bitstream further including an OMI SEI message that provides object mask information associated with a primary layer in which the OMI SEI message is present. The one or more constraints include a requirement that, for each first OMI mask identifier in the OMI SEI message, there is no second OMI mask identifier in the OMI SEI message that is associated with a same object mask auxiliary layer as the first OMI mask identifier and that has a same value as the first OMI mask identifier. Video decoder 300 may obtain a bitstream that includes encoded video data, the bitstream further including an OMI SEI message that provides object mask information associated with a primary layer in which the OMI SEI message is present. Video decoder 300 may then perform a bitstream conformance test on the bitstream that determines whether the bitstream complies with one or more constraints. The one or more constraints include a requirement that, for each first OMI mask identifier in the OMI SEI message, there is no second OMI mask identifier in the OMI SEI message that is associated with a same object mask auxiliary layer as the first OMI mask identifier and that has a same value as the first OMI mask identifier.

Alternatively or additionally, a constraint is proposed to apply to pri_region_id of packed regions information (PRI) SEI message as indicated below.
It is a requirement of bitstream conformance that the value of pri_region_id[i] shall not be the same for any two different values of i in the range of 0 to pri_num_regions_minus1, inclusive, in a PRI SEI message.
   The syntax element pri_region_id indicates the identifier of the i-th region. The syntax element pri_num_regions_minus1 plus 1 specifies the number of regions for which information is signaled.

Thus, in some examples, video encoder 200 generates a bitstream that includes encoded video data such that the bitstream conforms to one or more constraints. The bitstream further includes a PRI SEI message that provides packed region information regarding rectangular regions packed within a coded picture of the video data. The one or more constraints include a requirement that, for each first PRI region identifier in the PRI SEI message, there is no second PRI region identifier in the PRI SEI message that has a same value as the first PRI region identifier. In some examples, video decoder 300 obtains a bitstream that includes encoded video data. The bitstream further includes a PRI SEI message that provides packed region information regarding rectangular regions packed within a coded picture of the video data. Video decoder 300 performs a bitstream conformance test on the bitstream that determines whether the bitstream complies with one or more constraints. The one or more constraints include a requirement that, for each first PRI region identifier in the PRI SEI message, there is no second PRI region identifier in the PRI SEI message that has a same value as the first PRI region identifier.

An alternative or additional constraint for pri_region_id is as indicated below.
For i greater than 0, pri_region_id[i] shall be greater than pri_region_id [i−1].
   This constraint mandates that the identifiers for packed regions (pri_region_id′) are strictly increasing as the index ‘i’ increases. Specifically, for any PRI region index ‘i’ greater than 0, the identifier for that region (‘pri_region_id[i]’) is numerically larger than the identifier for the preceding region (pri_region_id [i−1]′). This requirement effectively sorts the regions by their identifier values in ascending order within the SEI message. By enforcing this order, the constraint ensures not only that every region identifier is unique but also that the parsing and processing of regions follow a predictable, strictly monotonic sequence.

### Constraint on the Source Objects or Regions

A constraint is proposed for OMI SEI messages to avoid empty object masks, as indicated below.
It is a requirement of bitstream conformance that there is at least one sample pI[i] [x][y] at location (x, y) in the cropped object mask picture in the i-th auxiliary layer associated with the current primary layer is associated with the object mask with the identifier of maskId[i][j] where j is in the range of 0 to (1<<(omi_mask_id_length_minus1+1))−1, inclusive.

This constraint provides that for any object mask identified by a mask identifier (maskId) in an OMI SEI message, there is at least one sample associated with that mask identifier located within the actual image area. This prevents the signaling of “empty” masks that possess an identifier but no corresponding spatial data. The OMI SEI message resides in a “current primary layer,” which typically carries the main video content. However, the actual shape data for the objects is stored in a separate “auxiliary layer” associated with the current primary layer. The OMI message links the current primary layer and the auxiliary layer by referencing the auxiliary layer (e.g., an object mask picture).

The constraint applies to the “cropped object mask picture.” In video coding, pictures are often padded with extra samples to fit block boundaries during encoding. These padding samples are cropped out to produce the final output. For the purposes of this conformance check, the dimensions and position of a cropped object mask picture are defined by conformance window parameters signaled in a parameter set associated with the object mask auxiliary layer, such as a Sequence Parameter Set (SPS) or Picture Parameter Set (PPS). Video decoder 300 applies the offsets specified by these parameters (e.g., conf_win_left_offset, conf_win_right_offset, conf_win_top_offset, and conf_win_bottom_offset) to the decoded auxiliary picture to determine the valid sample region (the cropped object mask picture) in which the existence of the mask identifier is to be verified.

This constraint provides that the valid sample verifying the mask's existence resides within the valid, cropped dimensions of the auxiliary picture, rather than in the discarded padding region. This constraint ensures that every mask identifier signaled in the metadata corresponds to actual visual data, thereby preventing video decoder 300 from wasting processing cycles or allocating memory for “empty” objects that do not exist in the scene. By verifying that mask samples reside within the valid cropped area rather than the discarded padding, the requirement eliminates ambiguity and ensures that object definitions remain consistent with the viewable video output.

The PRI SEI message provides information regarding rectangular regions packed with the coded picture. This information may optionally be used to reconstruct a target picture from the samples of the cropped decoded picture corresponding to the regions described in this SEI message. The PRI SEI message includes a pri_num_regions_minus1 syntax element. The pri_num_regions_minus1 syntax element, plus 1, specifies the total number of regions for which information is signaled within the PRI SEI message. The total number of regions for which information is signaled within the PRI SEI message determines the upper limit of the range used to verify that region identifiers (pri_region_id) are unique for each region defined in the message.

The PRI SEI message also includes pri_region_top_left_in_units_x[i] and pri_region_top_left_in_units_y[i] syntax elements that specify the horizontal and vertical positions, respectively, of the top left sample of the i-th region in units. The length of the syntax elements are pri_region_size_len_minus1+1. The variables priRegionTopLeftX[i] and priRegionTopLeftY[i], representing the horizontal and vertical positions, respectively, in luma samples of the i-th region in the cropped decoded picture with layer identifier equal to pri_region_layer_id[i], may be derived as follows:

```
if( !pri_use_max_dimensions_flag ) {
  priRegionTopLeftX[ i ] = pri_region_top_left_in_units_x[ i ] *
  priUnitSize
  priRegionTopLeftY[ i ] = pri_region_top_left_in_units_y[ i ] *
  priUnitSize
} else {
  priRegionTopLeftX[ i ] = ( pri_region_top_left_in_units_x[ i ] *
priUnitSize * PicWidthInLumaSamples + MaxPicWidth /2 ) / MaxWidth
  priRegionTopLeftY[ i ] = ( pri_region_top_left_in_units y[ i ] *
priUnitSize * PicHeightInLumaSamples + MaxPicHeight /2 ) / MaxHeight
}
```

Thus, pri_target_region_top_left_x[i] and pri_target_region_top_left_y[i], indicate the horizontal and vertical positions, respectively, of the top left sample position in luma samples of the i-th region in the reconstructed target picture. It is proposed to specify the range as below. In accordance with one or more techniques of this disclosure, it is proposed to specify the range, as specified below, to avoid a region outside the picture.
priRegionTopLeftX[i] shall be in the range of 0 to PicWidthInLumaSamples−1, inclusive.
priRegionTopLeftY[i] shall be in the range of 0 to PicHeightInLumaSamples−1, inclusive.
priRegionWidth[i] shall be in the range of 1 to PicWidthInLumaSamples−priRegionTopLeftX[i], inclusive.
priRegionHeight[i] shall be in the range of 1 to PicHeightInLumaSamples−priRegion TopLeftX[i], inclusive.
It is a requirement of bitstream conformance that priRegion TopLeftX[i]+priRegion Width[i] shall be less than or equal to MaxPicWidth, and priRegion TopLeftY[i]+priRegionHeight[i] shall be less than or equal to MaxPicHeight.

These constraints define the spatial boundaries of packed regions to ensure the packed regions are fully contained within the coded picture dimensions. Without such constraints, a bitstream could erroneously specify a region that extends beyond the picture boundary, potentially causing a video decoder to attempt to access invalid memory addresses or non-existent sample data. By requiring that the top-left coordinates and the region dimensions remain within the valid range of luma samples (e.g., ensuring priRegion TopLeftX plus priRegionWidth does not exceed MaxPicWidth), these rules prevent decoding failures such as crashes, interrupted playback, or degraded visual quality.

The Film Grain Regions Characteristics (FGRC) SEI message provides the decoder with a parameterized model for a film grain synthesis process. The FGRC SEI message includes an fgr_single_model_flag syntax element. The fgr_single_model_flag syntax element equal to 0 indicates that the fgr_regions_model_id[i] syntax element is present. fgr_regions_model_id[i] identifies the film grain simulation model for the i-th region in the picture. The fgr_single_model_flag syntax element equal to 1 indicates that the fgr_model_id syntax element is present. fgr_model_id identifies the film grain simulation model. The FGRC SEI message may also include fgr_region_top[i], fgr_region_left[i], fgr_region_width[i], and fgr_region_height[i] syntax elements that specify the coordinates of the top-left corner and the width and height, respectively, of the bounding box of the i-th region in the picture. In the FGRC SEI message, the regions shall not be overlapped, and the different film grain simulation model shall not apply to the same region. A conformance requirement is proposed as below.
It is a requirement of bitstream conformance that for each sample position (x, y) in the coded picture there shall be at most one rectangle, j, when fgr_single_model_flag is equal to 0, for which both of the following conditions apply:

$$x is in ( fgr\_region \_left [ i ] … fgr\_region \_left [ i ] + fgr\_region \_width [ i ] - 1 ) \\ y is in ( fgr\_region \_top [ i ] … fgr\_region \_top [ i ] + fgr\_region \_height [ i ] - 1 )$$

This conformance requirement prevents ambiguity during the film grain synthesis process by ensuring that no single sample position is subject to conflicting simulation models. If regions were permitted to overlap when fgr_single_model_flag is equal to 0, a specific pixel coordinate could be covered by multiple rectangles associated with different film grain parameters, making it unclear which model video decoder 300 should apply. By requiring that each sample position falls within at most one defined rectangle, the conformance requirement guarantees that the application of film grain is deterministic and that different simulation models are strictly spatially segregated across the picture.

An alternative or additional conformance requirement is to disallow overlapped regions for single film grain simulation model as indicated below.
It is a requirement of bitstream conformance that for each sample position (x, y) in the coded picture there shall be at most one rectangle, j, for which both of the following conditions apply:

$$x is in ( fgr\_region \_left [ i ] … fgr\_region \_left [ i ] + fgr\_region \_width [ i ] - 1 ) \\ y is in ( fgr\_region \_top [ i ] … fgr\_region \_top [ i ] + fgr\_region \_height [ i ] - 1 )$$

### Constraint on the Target Regions

In the PRI SEI message syntax element, pri_target_region_top_left_x[i] and pri_target_region_top_left_y[i], indicate the horizontal and vertical positions, respectively, of the top left sample position in luma samples of the i-th region in the reconstructed target picture. It is proposed to specify the range as indicated below.
pri_target_region_top_left_x[i] shall be in the range of 0 to pri_target_pic_width_minus1, inclusive.
pri_target_region_top_left_y[i] shall be in the range of 0 to pri_target_pic_height_minus1, inclusive.

These constraints are to ensure that the spatial coordinates defining the placement of packed regions remain strictly within the valid boundaries of the reconstructed target picture. By requiring the top-left horizontal and vertical positions to fall within the range of zero to the target picture width or height minus one, the constraints guarantee that the anchor point (i.e., top left corner) for every region exists within the actual sample array of the target frame. This prevents the bitstream from signaling invalid positions that could otherwise lead to rendering artifacts, memory access errors, or inconsistent decoder behavior when attempting to reconstruct the output picture.

### Constraint on the Order of the SEI Messages in SPO SEI Message

It is proposed to specify the following constraint on the order of the SEI messages in a SPO SEI message as indicated below.
For any two different integer values of m and n in the range of 0 to po_num_sei_messages_minus2+1, inclusive, when po_sei_payload_type[m] indicates the OMI SEI message and po_sei_payload_type[n] indicates the scalability dimension information (SDI) SEI message with sdi_aux_id[i] equal to AUX_OBJECT_MASK for at least one value of i, po_sei_processing_order[m] shall be greater than po_sei_processing_order[n].
For any two different integer values of m and n in the range of 0 to po_num_sei_messages_minus2+1, inclusive, when po_sei_payload_type[m] indicates the DOI SEI message with doi_partition_type_idc[i] equal to 1 for at least one value of i, and po_sei_payload_type[n] indicates the CR SEI message, po_sei_processing_order[m] shall be greater than po_sei processing_order[n].
For any two different integer values of m and n in the range of 0 to po_num_sei_messages_minus2+1, inclusive, when po_sei_payload_type[m] indicates the FRGC SEI message and po_sei_payload_type[n] indicates the SDI SEI message with sdi_aux_id[i] equal to 1 for at least one value of i, po_sei_processing_order[m] shall be greater than po_sei_processing_order[n].

Establishing these ordering constraints resolves processing dependencies where one SEI message relies on data defined by another. For instance, the OMI SEI message utilizes auxiliary layer definitions provided by the SDI SEI message. By mandating that the SDI message precedes the OMI message in the processing order (indicated by a lower ‘po_sei_processing_order’ value), the constraints ensure that the auxiliary layers are fully defined before the decoder attempts to apply mask information. This prevents errors that would arise from referencing undefined resources. Similarly, requiring Constituent Rectangle (CR) information to be processed before Display Overlay Information (DOI) ensures that the geometric building blocks are established before the decoder executes overlay operations. In this context, the CR SEI message defines the position and size of a set of rectangles that may be used for composition. The DOI SEI message specifies how these constituent rectangles are overlaid on the display. When the syntax element doi_partition_type_idc is equal to 1, the DOI SEI message explicitly references one or more constituent rectangles defined in a CR SEI message. Therefore, video decoder 300 processes the CR SEI message first to establish the definitions of the rectangles before processing the DOI SEI message that relies on those definitions to render the final overlay.

Constraint on the omi_mask_pic_update_flag and omi_num_mask_in_pic

When omi_mask_pic_update_flag[i] is equal to 0 or omi_num_mask_in_pic[i] is equal to 0, there is no mask object information present in the associated OMI SEI message. This happens when an OMI SEI message is first parsed in a current coded layer video sequence (CLVS), the OMI SEI message may contain no mask object at all. A constraint is proposed to avoid such scenario as follows.
It is a requirement of bitstream conformance that when OMI SEI message is parsed for the first time in the current CLVS, the value of the corresponding omi_mask_pic_update_flag[i] shall be equal to 1.
It is a requirement of bitstream conformance that when omi_mask_pic_update_flag[i] is parsed for the first time in the current CLVS, the value of the corresponding omi_num_mask_in_pic[i] shall not equal to 0.

The primary rationale for these constraints is to ensure that the OMI mechanism is properly initialized with valid data upon its first occurrence in a CLVS. Without these requirements, the first OMI SEI message could indicate an update status of zero, implying inheritance from a non-existent previous message, or specify zero masks, effectively resulting in an undefined or empty mask state for the sequence. Enforcing an explicit update and a non-zero mask count guarantees that the decoder receives concrete mask definitions immediately, thereby avoiding ambiguity and ensuring that the object mask auxiliary layer is correctly populated from the start.

### Signal Mandatory Stage Complexity for SPO SEI Message

The following table shows syntax elements proposed for the mandatory stage and sub-chain indicated by the SPO SEI message.

| | |
|---|---|
| po_mandatory_stage_info_present_flag | u(1) |
| if( po_mandatory_stage_info_present_flag ) { | |
| po_mandatory_stage_complexity_info( ) | |
| } | |
| po_sub_chain_info_enable_flag | u(1) |
| if( po_sub_chain_info_enable_flag ) { | |
| po_num_sub_chains | u(8) |
| for( i = 0; i < po_num_sub_chains; i++ ) { | |
| po_sub_chain_info_present_flag[ i ] | u(1) |
| if( po_sub_chain_info_present_flag[ i ] ) { | |
| po_subchain_complexity_info[ i ]( ) | |
| } | |
| } | |
| } | |

po_mandatory_stage_info_present_flag equal to 1 specifies po_mandatory_complexity_info( ) is present, po_mandatory_stage_info_present_flag equal to 0 specifies po_mandatory_complexity_info( ) is not present.

po_mandatory_stage_complexity_info( ) contains the complexity information of the mandatory stage indicated by the SPO SEI message.

po_sub_chain_info_enable_flag equal to 1 specifies that po_num_sub_chains is present. po_sub_chain_info_enable_flag equal to 0 specifies that po_num_sub_chains is not present.

po_num_sub_chains specifies the number of sub-chains indicated by the SPO SEI message. The value of po_num_sub_chains is from 0 to po_num_sei_messages_minus2+2, inclusive.

po_sub_chain_info_present_flag[i] equal to 1 specifies that complexity info for i-th sub-chain is present. po_sub_chain_info present_flag[i] equal to 0 specifies these syntax elements are not present for i-th sub-chain.

po_subchain_complexity_info[i]( ) contains the complexity information of i-th sub-chain indicated by SPO SEI message.

The po_mandatory_stage_complexity_info( ) syntax structure and the po_subchain_complexity_info( ) syntax structure may each be defined to include specific complexity parameters. Specifically, each of these structures includes a syntax element, such as po_num_kmac_operations_idc, indicating the maximum number of kilo-multiply-accumulate operations per second required for video decoder 300 to process the SEI messages in the associated stage or sub-chain. Each of these structures further includes a syntax element, such as po_total_kilobyte_size, indicating the maximum memory size required for video decoder 300 to store the SEI messages in the associated stage or sub-chain.

Thus, in some examples, a device (e.g., video decoder 300) may obtain a bitstream that includes encoded video data, the bitstream further including: a SEI processing order (SPO) SEI message that carries information indicating a processing order, as determined by an encoder, for a group of types of SEI messages, wherein the SPO SEI message includes one or of: more a first syntax element (e.g., po_mandatory_stage_info_present_flag) indicating whether processing order mandatory stage complexity information is present in the SPO SEI message, a second syntax element (e.g., po_sub_chain_info_enable_flag) indicating whether a third syntax element (po_num_sub_chains) is present, the third syntax element specifying a number of sub-chains indicated by the SPO SEI message, the third syntax element, a fourth syntax element (e.g., po_sub_chain_info_present_flag) indicating whether complexity information for a sub-chain is present in the SPO SEI message, or a fifth syntax element (e.g., po_subchain_complexity_info) containing complexity information of the sub-chain. The device may process additional SEI messages based on the processing order.

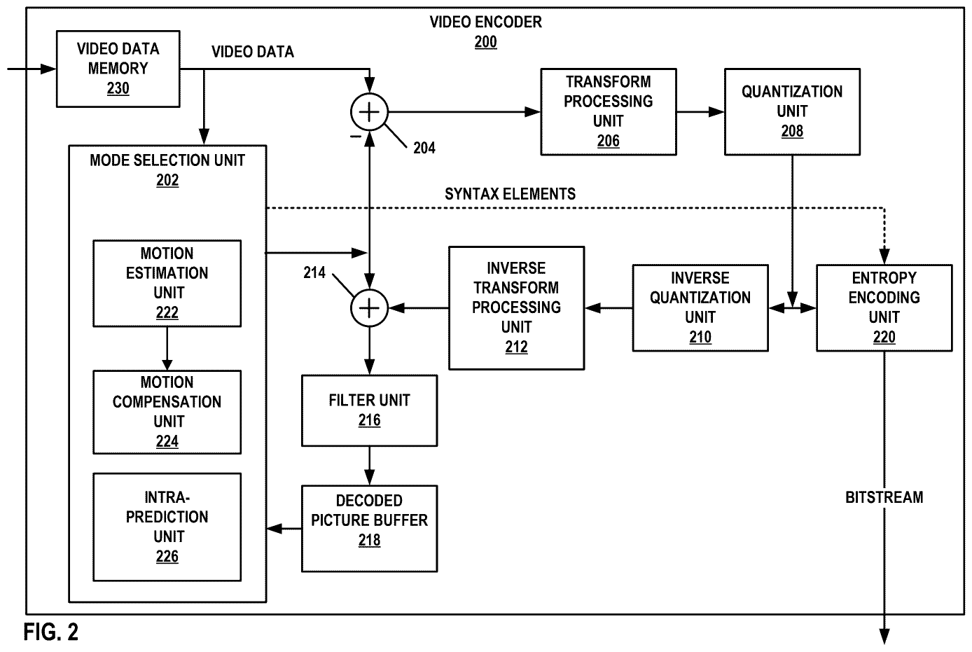

FIG. 2 is a block diagram illustrating an example video encoder 200 that may perform the techniques of this disclosure. FIG. 2 is provided for purposes of explanation and should not be considered limiting of the techniques as broadly exemplified and described in this disclosure. For purposes of explanation, this disclosure describes video encoder 200 according to the techniques of VVC and HEVC. However, the techniques of this disclosure may be performed by video encoding devices that are configured to other video coding standards and video coding formats, such as AV1 and successors to the AV1 video coding format.

In the example of FIG. 2, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 is an example of a memory system that may store video data to be encoded by the components of video encoder 200. Video encoder 200 may receive the video data stored in video data memory 230 from, for example, video source 104 (FIG. 1). DPB 218 is an example of a memory system that may act as a reference picture memory that stores reference video data for use in prediction of subsequent video data by video encoder 200. Video data memory 230 and DPB 218 may each be formed by any of a variety of one or more memory devices or memory units, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 2 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUS, transform types for residual data of the CUS, quantization parameters for residual data of the CUS, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure. superblock structure, or the quad-tree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

When operating according to the AV1 video coding format, intra-prediction unit 226 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 202 may include additional functional units to perform video prediction in accordance with other prediction modes.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 220 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device configured to encode video data including a memory configured to store video data, and one or more processing units implemented in circuitry and configured to generate a bitstream that include SEI messages and conforms to any of the constraints described in this disclosure.

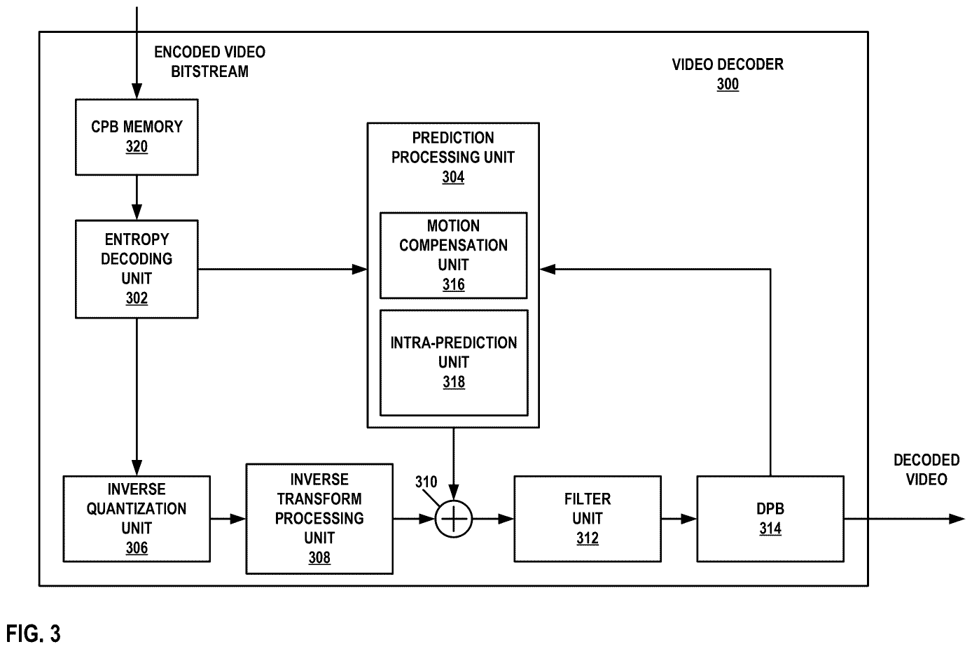

FIG. 3 is a block diagram illustrating an example video decoder 300 that may perform the techniques of this disclosure. FIG. 3 is provided for purposes of explanation and is not limiting on the techniques as broadly exemplified and described in this disclosure. For purposes of explanation, this disclosure describes video decoder 300 according to the techniques of VVC and HEVC. However, the techniques of this disclosure may be performed by video coding devices that are configured to other video coding standards.

In the example of FIG. 3, video decoder 300 includes coded picture buffer (CPB) memory 320, entropy decoding unit 302, prediction processing unit 304, inverse quantization unit 306, inverse transform processing unit 308, reconstruction unit 310, filter unit 312, and DPB 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, motion compensation unit 316 may be configured to decode coding blocks of video data (e.g., both luma and chroma coding blocks) using translational motion compensation, affine motion compensation, OBMC, and/or compound inter-intra prediction, as described above. Intra-prediction unit 318 may be configured to decode coding blocks of video data (e.g., both luma and chroma coding blocks) using directional intra prediction, non-directional intra prediction, recursive filter intra prediction, CFL, IBC, and/or color palette mode, as described above.

CPB memory 320 is an example of a memory system that may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 is an example of a memory system that generally stores decoded pictures, which video decoder 300 may output and/or use as reference video data when decoding subsequent data or pictures of the encoded video bitstream. CPB memory 320 and DPB 314 may each be formed by any of a variety of memory devices or memory units, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 3 are illustrated to assist with understanding the operations performed by video decoder 300. The units may be implemented as fixed-function circuits, programmable circuits, or a combination thereof. Similar to FIG. 2, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 2).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 2). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a video decoding device including a memory configured to store video data, and one or more processing units implemented in circuitry and configured to obtain a bitstream that includes encoded video data, the bitstream further including SEI messages in accordance with examples of this disclosure. The one or more processing units may perform a bitstream conformance test to determine whether the bitstream complies with any of the one or more constraints described in this disclosure.

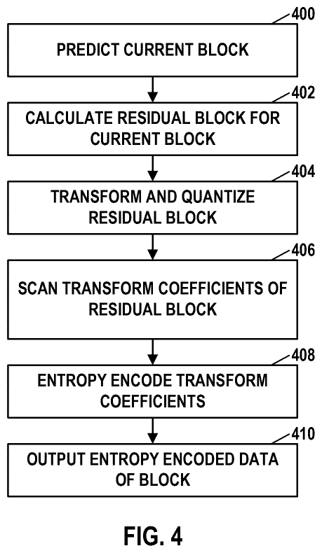

FIG. 4 is a flowchart illustrating an example method for encoding a current block in accordance with the techniques of this disclosure. The current block may be or may include a current CU. Although described with respect to video encoder 200 (FIGS. 1 and 2), it should be understood that other devices may be configured to perform a method similar to that of FIG. 4.

In this example, video encoder 200 initially predicts the current block (400). For example, video encoder 200 may form a prediction block for the current block. Video encoder 200 may then calculate a residual block for the current block (402). To calculate the residual block, video encoder 200 may calculate a difference between the original, unencoded block and the prediction block for the current block. Video encoder 200 may then transform the residual block and quantize transform coefficients of the residual block (404). Next, video encoder 200 may scan the quantized transform coefficients of the residual block (406). During the scan, or following the scan, video encoder 200 may entropy encode the transform coefficients (408). For example, video encoder 200 may encode the transform coefficients using CAVLC or CABAC. Video encoder 200 may then output the entropy encoded data of the block (410).

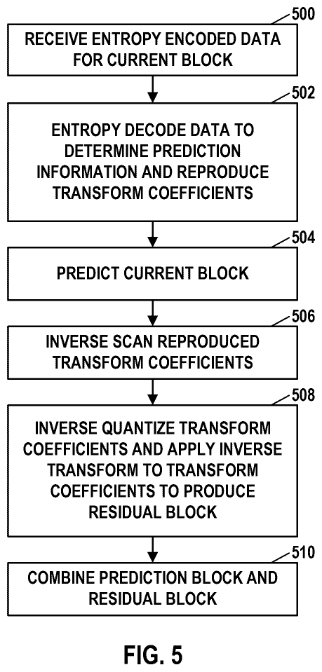

FIG. 5 is a flowchart illustrating an example method for decoding a current block of video data in accordance with the techniques of this disclosure. The current block may be or include a current CU. Although described with respect to video decoder 300 (FIGS. 1 and 3), it should be understood that other devices may be configured to perform a method similar to that of FIG. 5.

Video decoder 300 may receive entropy encoded data for the current block, such as entropy encoded prediction information and entropy encoded data for transform coefficients of a residual block corresponding to the current block (500). Video decoder 300 may entropy decode the entropy encoded data to determine prediction information for the current block and to reproduce transform coefficients of the residual block (502). Video decoder 300 may predict the current block (504), e.g., using an intra- or inter-prediction mode as indicated by the prediction information for the current block, to calculate a prediction block for the current block. Video decoder 300 may then inverse scan the reproduced transform coefficients (506), to create a block of quantized transform coefficients. Video decoder 300 may then inverse quantize the transform coefficients and apply an inverse transform to the transform coefficients to produce a residual block (508). Video decoder 300 may ultimately decode the current block by combining the prediction block and the residual block (510).

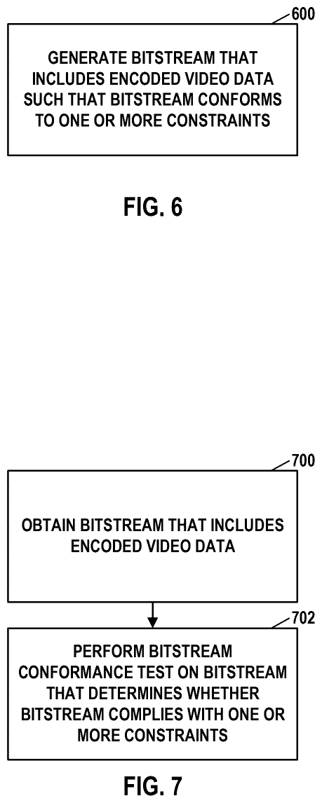

FIG. 6 is a flowchart illustrating an example method of encoding video data in accordance with the techniques of this disclosure. Video encoder 200 generates a bitstream that includes encoded video data such that the bitstream conforms to one or more constraints (600). In some examples, the bitstream includes an OMI SEI message that provides object mask information associated with a primary layer in which the OMI SEI message is present. In such examples, the one or more constraints may include a requirement that, for each first OMI mask identifier in the OMI SEI message, there is no second OMI mask identifier in the OMI SEI message that is associated with a same object mask auxiliary layer as the first OMI mask identifier and that has a same value as the first OMI mask identifier. In some examples, the one or more constraints include a requirement that there is at least one sample is associated with an object mask having the first OMI mask identifier, where the at least one sample is at a first location in a cropped object mask picture in an auxiliary layer associated with the primary layer.

Alternatively, or in addition, the OMI SEI message includes a syntax element indicating whether object mask information of the object mask auxiliary layer is updated. The one or more constraints include a requirement that, when the OMI SEI message is parsed for a first time in a current CLVS, a value of the syntax element shall be equal to 1. The OMI SEI message may include a second syntax element specifying a number of object masks of the object mask auxiliary layer. The one or more constraints may include a requirement that, when the syntax element is parsed for the first time in the current CLVS, a value of the second syntax element shall not be equal to 0.

In addition to the OMI and PRI constraints described above, video encoder 200 may generate the bitstream to include an SEI processing order (SPO) SEI message that carries information indicating a processing order, as determined by an encoder, for a group of types of SEI messages. The SPO SEI message includes a first syntax element having a first value, wherein the first value plus 2 indicates a number of types of SEI messages for which the processing order is indicated in the SPO SEI message. The SPO SEI message includes second syntax elements indicating payload type values for the SEI messages, and the SPO SEI message includes two or more third syntax elements indicating SEI processing orders.

In some examples of the method illustrated in FIG. 6, video encoder 200 generates the bitstream to include a PRI SEI message. The PRI SEI message provides packed region information regarding rectangular regions packed within a coded picture of the video data. Video encoder 200 generates the bitstream such that the bitstream conforms to one or more constraints associated with this PRI SEI message.

One such constraint includes a requirement that, for each first PRI region identifier in the PRI SEI message, there is no second PRI region identifier in the PRI SEI message that has a same value as the first PRI region identifier. This ensures that every region defined within the message possesses a unique identifier. Additionally or alternatively, video encoder 200 may enforce spatial constraints on the source regions. For instance, the one or more constraints may include a requirement that a horizontal position of a top left sample of a region is in a range of 0 to a width of the coded picture in luma samples minus 1. Similarly, the constraints may require that a vertical position of the top left sample of the region is in a range of 0 to a height of the coded picture in luma samples minus 1.

Additionally or alternatively, the constraints may require that a horizontal position of a top left sample of a region plus a width of the region is less than or equal to a maximum width of the coded picture. Likewise, the constraints may require that a vertical position of the top left sample of the region plus a height of the region is less than or equal to a maximum height of the coded picture.

Additionally or alternatively, when the PRI SEI message includes information regarding a reconstructed target picture, the constraints may strictly define the bounds of the target region. Specifically, the one or more constraints may include a requirement that a horizontal position of a top left sample of a region in the reconstructed target picture is in a range of 0 to a width of the reconstructed target picture minus 1. The constraints may also require that a vertical position of the top left sample of the region in the reconstructed target picture is in a range of 0 to a height of the reconstructed target picture minus 1.

FIG. 7 is a flowchart illustrating an example method of processing video data in accordance with the techniques of this disclosure. Video decoder 300 obtains a bitstream that includes encoded video data (700). Video decoder 300 performs a bitstream conformance test on the bitstream that determines whether the bitstream complies with one or more constraints (702).

In examples where the bitstream further includes an OMI SEI message that provides object mask information associated with a primary layer in which the OMI SEI message is present, the one or more constraints include a requirement that, for each first OMI mask identifier in the OMI SEI message, there is no second OMI mask identifier in the OMI SEI message that is associated with a same object mask auxiliary layer as the first OMI mask identifier and that has a same value as the first OMI mask identifier. Furthermore, the one or more constraints may include a requirement that there is at least one sample is associated with an object mask having the first OMI mask identifier, where the at least one sample is at a first location in a cropped object mask picture in an auxiliary layer associated with the primary layer.

Regarding initialization of the OMI SEI message, the OMI SEI message may include a syntax element indicating whether object mask information of the object mask auxiliary layer is updated. The one or more constraints include a requirement that, when the OMI SEI message is parsed for a first time in a current CLVS, a value of the syntax element shall be equal to 1. Additionally, the OMI SEI message includes a second syntax element specifying a number of object masks of the object mask auxiliary layer. The one or more constraints include a requirement that, when the syntax element is parsed for the first time in the current CLVS, a value of the second syntax element shall not be equal to 0.

In examples where the bitstream further includes a PRI SEI message that provides packed region information regarding rectangular regions packed within a coded picture of the video data, the one or more constraints include a requirement that, for each first PRI region identifier in the PRI SEI message, there is no second PRI region identifier in the PRI SEI message that has a same value as the first PRI region identifier.

Video decoder 300 may also verify spatial constraints. The one or more constraints may include a requirement that a horizontal position of a top left sample of a region is in a range of 0 to a width of the coded picture in luma samples minus 1, and that a vertical position of the top left sample of the region is in a range of 0 to a height of the coded picture in luma samples minus 1. Additionally, the one or more constraints include a requirement that a horizontal position of a top left sample of a region plus a width of the region is less than or equal to a maximum width of the coded picture, and that a vertical position of the top left sample of the region plus a height of the region is less than or equal to a maximum height of the coded picture.

Finally, the PRI SEI message may include information regarding a reconstructed target picture. In this case, the one or more constraints include a requirement that a horizontal position of a top left sample of a region in the reconstructed target picture is in a range of 0 to a width of the reconstructed target picture minus 1, and that a vertical position of the top left sample of the region in the reconstructed target picture is in a range of 0 to a height of the reconstructed target picture minus 1.

The following numbered clauses illustrate one or more aspects of the devices and techniques described in this disclosure.
Clause 1A. A method of processing video data, the method comprising: obtaining a bitstream that includes encoded video data, the bitstream further including an Object Mask Information (OMI) Supplemental Enhancement Information (SEI) message that provides object mask information associated with a layer in which the OMI SEI message is present; and performing a bitstream conformance test on the bitstream that determines whether the bitstream complies with one or more constraints, wherein the one or more constraints include a requirement that, for each first OMI mask identifier in the OMI SEI message, there is no second OMI mask identifier in the OMI SEI message that is associated with a same object mask auxiliary layer as the first OMI mask identifier and that has a same value as the first OMI mask identifier.
Clause 2A. A method of processing video data, the method comprising: generating a bitstream that includes encoded video data such that the bitstream conforms to one or more constraints, the bitstream further including an Object Mask Information (OMI) Supplemental Enhancement Information (SEI) message that provides object mask information associated with a layer in which the OMI SEI message is present, wherein the one or more constraints include a requirement that, for each first OMI mask identifier in the OMI SEI message, there is no second OMI mask identifier in the OMI SEI message that is associated with a same object mask auxiliary layer as the first OMI mask identifier and that has a same value as the first OMI mask identifier.
Clause 3A. A method of processing video data, the method comprising: obtaining a bitstream that includes encoded video data, the bitstream further including a Packed Region Information (PRI) Supplemental Enhancement Information (SEI) message that provides packed region information regarding rectangular regions packed within a coded picture of the video data; and performing a bitstream conformance test on the bitstream that determines whether the bitstream complies with one or more constraints, wherein the one or more constraints include a requirement that, for each first PRI region identifier in the PRI SEI message, there is no second PRI region identifier in the PRI SEI message that has a same value as the first PRI region identifier.
Clause 4A. A method of processing video data, the method comprising: generating a bitstream that includes encoded video data such that the bitstream conforms to one or more constraints, the bitstream further including a Packed Region Information (PRI) Supplemental Enhancement Information (SEI) message that provides packed region information regarding rectangular regions packed within a coded picture of the video data, wherein the one or more constraints include a requirement that, for each first PRI region identifier in the PRI SEI message, there is no second PRI region identifier in the PRI SEI message that has a same value as the first PRI region identifier.
Clause 5A. A method of processing video data, the method comprising: obtaining a bitstream that includes encoded video data, the bitstream further including an Object Mask Information (OMI) Supplemental Enhancement Information (SEI) message that provides object mask information associated with a primary layer in which the OMI SEI message is present; and performing a bitstream conformance test on the bitstream that determines whether the bitstream complies with one or more constraints, wherein the one or more constraints include a requirement that there is at least one sample at a first location in a cropped object mask picture in an auxiliary layer associated with the primary layer is associated with an object mask with a mask identifier associated with the auxiliary layer.
Clause 6A. A method of processing video data, the method comprising: generating a bitstream that includes encoded video data such that the bitstream conforms to one or more constraints, the bitstream further including an Object Mask Information (OMI) Supplemental Enhancement Information (SEI) message that provides object mask information associated with a primary layer in which the OMI SEI message is present, wherein the one or more constraints include a requirement that there is at least one sample at a first location in a cropped object mask picture in an auxiliary layer associated with the primary layer is associated with an object mask with a mask identifier associated with the auxiliary layer.
Clause 7A. A method of processing video data, the method comprising: obtaining a bitstream that includes encoded video data, the bitstream further including a Packed Region Information (PRI) Supplemental Enhancement Information (SEI) message that provides packed region information regarding rectangular regions packed within a coded picture of the video data; and performing a bitstream conformance test on the bitstream that determines whether the bitstream complies with one or more constraints, wherein the one or more constraints include a requirement that at least one of: a horizontal position of a top left sample of a region is in a range of 0 to a width of a picture in luma samples, that a vertical position of the top left sample of the region is in a range of 0 to a height of the picture in luma samples, that a width of the region is in a range of 1 to the width of the picture in luma samples, that a height of the region is in a range of 1 to the height of the picture in luma samples, the horizontal position of the top left sample of the region plus a width of the region shall be less than or equal to a maximum width of the picture, or the vertical position of the top left sample of the region plus a height of the region shall be less than or equal to a maximum height of the picture.
Clause 8A. A method of processing video data, the method comprising: generating a bitstream that includes encoded video data such that the bitstream conforms to one or more constraints, the bitstream further including a Packed Region Information (PRI) Supplemental Enhancement Information (SEI) message that provides packed region information regarding rectangular regions packed within a coded picture of the video data, wherein the one or more constraints include a requirement that at least one of: a horizontal position of a top left sample of a region is in a range of 0 to a width of a picture in luma samples, that a vertical position of the top left sample of the region is in a range of 0 to a height of the picture in luma samples, that a width of the region is in a range of 1 to the width of the picture in luma samples, that a height of the region is in a range of 1 to the height of the picture in luma samples, the horizontal position of the top left sample of the region plus a width of the region shall be less than or equal to a maximum width of the picture, or the vertical position of the top left sample of the region plus a height of the region shall be less than or equal to a maximum height of the picture.
Clause 9A. A method of processing video data, the method comprising: obtaining a bitstream that includes encoded video data, the bitstream further including a Film Grain Regions Characteristics (FGRC) Supplemental Enhancement Information (SEI) message that provides a decoder with a parameterized model for a film grain synthesis process; and performing a bitstream conformance test on the bitstream that determines whether the bitstream complies with one or more constraints, wherein the one or more constraints include: (i) a requirement that film grain regions specified by the FGRC SEI message do not overlap, or (ii) a requirement that different film grain simulation models do not apply to a single one of the film grain regions specified by the FGRC SEI message.
Clause 10A. A method of processing video data, the method comprising: generating a bitstream that includes encoded video data such that the bitstream conforms to one or more constraints, the bitstream further including a Film Grain Regions Characteristics (FGRC) Supplemental Enhancement Information (SEI) message that provides a decoder with a parameterized model for a film grain synthesis process, wherein the one or more constraints include: (i) a requirement that film grain regions specified by the FGRC SEI message do not overlap, or (ii) a requirement that different film grain simulation models do not apply to a single one of the film grain regions specified by the FGRC SEI message.
Clause 11A. A method of processing video data, the method comprising: obtaining a bitstream that includes encoded video data, the bitstream further including a Packed Region Information (PRI) Supplemental Enhancement Information (SEI) message that provides packed region information regarding rectangular regions packed within a coded picture of the video data; and performing a bitstream conformance test on the bitstream that determines whether the bitstream complies with one or more constraints, wherein the one or more constraints include a requirement that a value of a first syntax element specifying an x component of a top left sample position of a region in a reconstructed target picture shall be in a range of 0 to a value of a second syntax element specifying a target picture width minus 1, and a value of a third syntax element specifying a y component of the top left sample position of the region shall be in a range of 0 to a value of a fourth syntax element specifying a target picture height minus 1.
Clause 12A. A method of processing video data, the method comprising: generating a bitstream that includes encoded video data such that the bitstream conforms to one or more constraints, the bitstream further including a Packed Region Information (PRI) Supplemental Enhancement Information (SEI) message that provides packed region information regarding rectangular regions packed within a coded picture of the video data, wherein the one or more constraints include a requirement that a value of a first syntax element specifying an x component of a top left sample position of a region in a reconstructed target picture shall be in a range of 0 to a value of a second syntax element specifying a target picture width minus 1, and a value of a third syntax element specifying a y component of the top left sample position of the region shall be in a range of 0 to a value of a fourth syntax element specifying a target picture height minus 1.
Clause 13A. A method of processing video data, the method comprising: obtaining a bitstream that includes encoded video data, the bitstream further including: an Object Mask Information (OMI) Supplemental Enhancement Information (SEI) message that provides object mask information associated with a layer in which the OMI SEI message is present; and a SEI processing order (SPO) SEI message that carries information indicating a processing order, as determined by an encoder, for a group of types of SEI messages, wherein the SPO SEI message includes a first syntax element (e.g., po_num_sei_messages_minus2) having a first value, wherein the first value plus 2 indicating a number of types of SEI messages for which the processing order is indicated in the SPO SEI message, the SPO SEI message includes second syntax elements (e.g., po_sei_payload_type) indicating payload type values for the SEI messages, and the SPO SEI message includes two or more third syntax elements (e.g., ps_sei_processing_order) indicating SEI processing orders; and performing a bitstream conformance test on the bitstream that determines whether the bitstream complies with one or more constraints, wherein the one or more constraints include one or more of: a first requirement that, for any two different integer values of m and n in a range of 0 to the first value plus 1, when a first second syntax element of the second syntax elements having index m indicates the OMI SEI message and a second second syntax element of the second syntax elements having index n indicates a first SDI SEI message with a first SDI auxiliary identifier having a value indicating an auxiliary object mask number, a first third syntax element of the third syntax elements having index m shall be greater than a second third syntax element of the third syntax elements having index n, a second requirement that, for any two different integer values of m and n in a range of 0 to the first value plus 1, when the first second syntax element having index m indicates a display overlay information (DOI) SEI message with a DOI partition type indicator syntax element equal to 1 and the second second syntax element having index n indicates a Constituent Rectangle (CR) SEI message, the first third syntax element of the third syntax elements having index m shall be greater than the second third syntax element of the third syntax elements having index n, or a third requirement that, for any two different integer values of m and n in a range of 0 to the first value plus 1, when the first second syntax element having index m indicates a Film Grain Regions Characteristics (FGRC) SEI message and the second second syntax element having index n indicates a second SDI SEI message with a second SDI auxiliary identifier equal to 1, the first third syntax element of the third syntax elements having index m shall be greater than the second third syntax element of the third syntax elements having index n.
Clause 14A. A method of processing video data, the method comprising: generating a bitstream that includes encoded video data such that the bitstream conforms to one or more constraints, the bitstream further including an Object Mask Information (OMI) Supplemental Enhancement Information (SEI) message that provides object mask information associated with a layer in which the OMI SEI message is present; and a SEI processing order (SPO) SEI message that carries information indicating a processing order, as determined by an encoder, for a group of types of SEI messages, wherein the SPO SEI message includes a first syntax element (e.g., po_num_sei_messages_minus2) having a first value, wherein the first value plus 2 indicating a number of types of SEI messages for which the processing order is indicated in the SPO SEI message, the SPO SEI message includes second syntax elements (e.g., po_sei_payload_type) indicating payload type values for the SEI messages, and the SPO SEI message includes two or more third syntax elements (e.g., ps_sei_processing_order) indicating SEI processing orders, wherein the one or more constraints include one or more of: a first requirement that, for any two different integer values of m and n in a range of 0 to the first value plus 1, when a first second syntax element of the second syntax elements having index m indicates the OMI SEI message and a second second syntax element of the second syntax elements having index n indicates a first SDI SEI message with a first SDI auxiliary identifier having a value indicating an auxiliary object mask number, a first third syntax element of the third syntax elements having index m shall be greater than a second third syntax element of the third syntax elements having index n, a second requirement that, for any two different integer values of m and n in a range of 0 to the first value plus 1, when the first second syntax element having index m indicates a display overlay information (DOI) SEI message with a DOI partition type indicator syntax element equal to 1 and the second second syntax element having index n indicates a Constituent Rectangle (CR) SEI message, the first third syntax element of the third syntax elements having index m shall be greater than the second third syntax element of the third syntax elements having index n, or a third requirement that, for any two different integer values of m and n in a range of 0 to the first value plus 1, when the first second syntax element having index m indicates a Film Grain Regions Characteristics (FGRC) SEI message and the second second syntax element having index n indicates a second SDI SEI message with a second SDI auxiliary identifier equal to 1, the first third syntax element of the third syntax elements having index m shall be greater than the second third syntax element of the third syntax elements having index n.
Clause 15A. A method of processing video data, the method comprising: obtaining a bitstream that includes encoded video data, the bitstream further including an Object Mask Information (OMI) Supplemental Enhancement Information (SEI) message that provides object mask information associated with a current primary layer in which the OMI SEI message is present, the OMI SEI message including a first syntax element (e.g., omi_mask_pic_update_flag) that indicates whether object mask information of an object mask auxiliary layer is associated with the current primary layer is updated, a second syntax element (e.g., omi_num_mask_in_pic_update) specifying a number of object masks of the object mask auxiliary layer; and performing a bitstream conformance test on the bitstream that determines whether the bitstream complies with one or more constraints, wherein the one or more constraints include one or more of: a first requirement that, when the OMI SEI message is parsed for a first time in a current coded layer video sequence (CLVS), a value of the first syntax element shall be equal to 1; or a second requirement that, when the first syntax element is parsed for the first time in the current CLVS, a value of the second syntax element shall not be equal to 0.
Clause 16A. A method of processing video data, the method comprising: generating a bitstream that includes encoded video data such that the bitstream conforms to one or more constraints, the bitstream further including an Object Mask Information (OMI) Supplemental Enhancement Information (SEI) message that provides object mask information associated with a current primary layer in which the OMI SEI message is present, the OMI SEI message including a first syntax element (e.g., omi_mask_pic_update_flag) that indicates whether object mask information of an object mask auxiliary layer is associated with the current primary layer is updated, a second syntax element (e.g., omi_num_mask_in_pic_update) specifying a number of object masks of the object mask auxiliary layer, wherein the one or more constraints include one or more of: a first requirement that, when the OMI SEI message is parsed for a first time in a current coded layer video sequence (CLVS), a value of the first syntax element shall be equal to 1; or a second requirement that, when the first syntax element is parsed for the first time in the current CLVS, a value of the second syntax element shall not be equal to 0.
Clause 17A. A method of processing video data, the method comprising: obtaining a bitstream that includes encoded video data, the bitstream further including: a SEI processing order (SPO) SEI message that carries information indicating a processing order, as determined by an encoder, for a group of types of SEI messages, wherein the SPO SEI message includes one or more of: a first syntax element (e.g., po_mandatory_stage_info_present_flag) indicating whether processing order mandatory stage complexity information is present in the SPO SEI message, a second syntax element (e.g., po_sub_chain_info_enable_flag) indicating whether a third syntax element (e.g., po_num_sub_chains) is present, the third syntax element specifying a number of sub-chains indicated by the SPO SEI message, the third syntax element, a fourth syntax element (e.g., po_sub_chain_info_present_flag) indicating whether complexity information for a sub-chain is present in the SPO SEI message, or a fifth syntax element (e.g., po_subchain_complexity_info) containing complexity information of the sub-chain; and processing additional SEI messages based on the processing order.
Clause 18A. A method of processing video data, the method comprising: generating a bitstream that includes encoded video data, the bitstream further including: a SEI processing order (SPO) SEI message that carries information indicating a processing order, as determined by an encoder, for a group of types of SEI messages, wherein the SPO SEI message includes one or more of: a first syntax element (e.g., po_mandatory_stage_info_present_flag) indicating whether processing order mandatory stage complexity information is present in the SPO SEI message, a second syntax element (e.g., po_sub_chain_info_enable_flag) indicating whether a third syntax element (e.g., po_num_sub_chains) is present, the third syntax element specifying a number of sub-chains indicated by the SPO SEI message, the third syntax element, a fourth syntax element (e.g., po_sub_chain_info_present_flag) indicating whether complexity information for a sub-chain is present in the SPO SEI message, or a fifth syntax element (e.g., po_subchain_complexity_info) containing complexity information of the sub-chain.
Clause 19A. The methods of any of clauses 1A, 3A, 5A, 7A, 9A, 11A, 13A, or 15A, further comprising decoding the encoded video data based on the bitstream passing the bitstream conformance test.
Clause 20A. The methods of any of clauses 1A, 3A, 5A, 7A, 9A, 11A, 13A, 15A, or 17A, further comprising decoding the encoded video data based at least in part on syntax elements included in at least one of the OMI SEI message, PRI SEI message, FGRC SEI message, SPO SEI message, or CR SEI message.
Clause 21A. A method combining steps of methods of any of clauses 1A-20A.
Clause 22A. A device for coding video data, the device comprising one or more means for performing the method of any of clauses 1A-21A.
Clause 23A. The device of clause 22A, wherein the one or more means comprise one or more processors implemented in circuitry.
Clause 24A. The device of any of clauses 22A and 23A, further comprising a memory to store the video data.
Clause 25A. The device of any of clauses 22A-24A, further comprising a display configured to display decoded video data.
Clause 26A. The device of any of clauses 22A-25A, wherein the device comprises one or more of a camera, a computer, a mobile device, a broadcast receiver device, or a set-top box.
Clause 27A. The device of any of clauses 22A-26A, wherein the device comprises a video decoder.
Clause 28A. The device of any of clauses 22A-27A, wherein the device comprises a video encoder.
Clause 29A. A computer-readable storage medium having stored thereon instructions that, when executed, cause one or more processors to perform the method of any of clauses 1A-21A.
Clause 1B. A device for processing video data, the device comprising a memory configured to store video data, and one or more processors implemented in circuitry and configured to obtain a bitstream that includes encoded video data, the bitstream further including an Object Mask Information (OMI) Supplemental Enhancement Information (SEI) message that provides object mask information associated with a primary layer in which the OMI SEI message is present, and perform a bitstream conformance test on the bitstream that determines whether the bitstream complies with one or more constraints, wherein the one or more constraints include a requirement that, for each first OMI mask identifier in the OMI SEI message, there is no second OMI mask identifier in the OMI SEI message that is associated with a same object mask auxiliary layer as the first OMI mask identifier and that has a same value as the first OMI mask identifier.
Clause 2B. The device of Clause 1B, wherein the one or more constraints include a requirement that there is at least one sample associated with an object mask having the first OMI mask identifier, wherein the at least one sample is at a first location in a cropped object mask picture in an auxiliary layer associated with the primary layer.
Clause 3B. The device of any of Clauses 1B-2B, wherein the OMI SEI message includes a syntax element indicating whether object mask information of a specific object mask auxiliary layer is updated, and wherein the one or more constraints include a requirement that, when the OMI SEI message is parsed for a first time in a current coded layer video sequence (CLVS), a value of the syntax element shall be equal to 1.
Clause 4B. The device of Clause 3B, wherein the syntax element is a first syntax element and the OMI SEI message includes a second syntax element specifying a number of object masks of the specific object mask auxiliary layer, and wherein the one or more constraints include a requirement that, when the first syntax element is parsed for the first time in the current CLVS, a value of the second syntax element shall not be equal to 0.
Clause 5B. The device of any of Clauses 1B-4B, wherein the one or more processors are further configured to decode the encoded video data based on the bitstream passing the bitstream conformance test.
Clause 6B. A device for processing video data, the device comprising a memory configured to store video data, and one or more processors implemented in circuitry and configured to generate a bitstream that includes encoded video data such that the bitstream conforms to one or more constraints, the bitstream further including an Object Mask Information (OMI) Supplemental Enhancement Information (SEI) message that provides object mask information associated with a primary layer in which the OMI SEI message is present, wherein the one or more constraints include a requirement that, for each first OMI mask identifier in the OMI SEI message, there is no second OMI mask identifier in the OMI SEI message that is associated with a same object mask auxiliary layer as the first OMI mask identifier and that has a same value as the first OMI mask identifier.
Clause 7B. The device of Clause 6B, wherein the one or more constraints include a requirement that there is at least one sample associated with an object mask having the first OMI mask identifier, wherein the at least one sample is at a first location in a cropped object mask picture in an auxiliary layer associated with the primary layer.
Clause 8B. The device of any of Clauses 6B-7B, wherein the OMI SEI message includes a syntax element indicating whether object mask information of a specific object mask auxiliary layer is updated, and wherein the one or more constraints include a requirement that, when the OMI SEI message is parsed for a first time in a current coded layer video sequence (CLVS), a value of the syntax element shall be equal to 1.
Clause 9B. The device of Clause 8B, wherein the syntax element is a first syntax element and the OMI SEI message includes a second syntax element specifying a number of object masks of the specific object mask auxiliary layer, and wherein the one or more constraints include a requirement that, when the first syntax element is parsed for the first time in the current CLVS, a value of the second syntax element shall not be equal to 0.
Clause 10B. A device for processing video data, the device comprising a memory configured to store video data, and one or more processors implemented in circuitry and configured to obtain a bitstream that includes encoded video data, the bitstream further including a Packed Region Information (PRI) Supplemental Enhancement Information (SEI) message that provides packed region information regarding rectangular regions packed within a coded picture of the video data, and perform a bitstream conformance test on the bitstream that determines whether the bitstream complies with one or more constraints, wherein the one or more constraints include a requirement that, for each first PRI region identifier in the PRI SEI message, there is no second PRI region identifier in the PRI SEI message that has a same value as the first PRI region identifier.
Clause 11B. The device of Clause 10B, wherein the one or more constraints include a requirement that a horizontal position of a top left sample of a region is in a range of 0 to a width of the coded picture in luma samples minus 1, and that a vertical position of the top left sample of the region is in a range of 0 to a height of the coded picture in luma samples minus 1.
Clause 12B. The device of any of Clauses 10B-11B, wherein the one or more constraints include a requirement that a horizontal position of a top left sample of a region plus a width of the region is less than or equal to a maximum width of the coded picture, and that a vertical position of the top left sample of the region plus a height of the region is less than or equal to a maximum height of the coded picture.
Clause 13B. The device of any of Clauses 10B-12B, wherein the PRI SEI message includes information regarding a reconstructed target picture, and wherein the one or more constraints include a requirement that a horizontal position of a top left sample of a region in the reconstructed target picture is in a range of 0 to a width of the reconstructed target picture minus 1, and that a vertical position of the top left sample of the region in the reconstructed target picture is in a range of 0 to a height of the reconstructed target picture minus 1.
Clause 14B. The device of any of Clauses 10B-13B, wherein the one or more processors are further configured to decode the encoded video data based on the bitstream passing the bitstream conformance test.
Clause 15B. A device for processing video data, the device comprising a memory configured to store video data, and one or more processors implemented in circuitry and configured to generate a bitstream that includes encoded video data such that the bitstream conforms to one or more constraints, the bitstream further including a Packed Region Information (PRI) Supplemental Enhancement Information (SEI) message that provides packed region information regarding rectangular regions packed within a coded picture of the video data, wherein the one or more constraints include a requirement that, for each first PRI region identifier in the PRI SEI message, there is no second PRI region identifier in the PRI SEI message that has a same value as the first PRI region identifier.
Clause 16B. The device of Clause 15B, wherein the one or more constraints include a requirement that a horizontal position of a top left sample of a region is in a range of 0 to a width of the coded picture in luma samples minus 1, and that a vertical position of the top left sample of the region is in a range of 0 to a height of the coded picture in luma samples minus 1.
Clause 17B. The device of any of Clauses 15B-16B, wherein the one or more constraints include a requirement that a horizontal position of a top left sample of a region plus a width of the region is less than or equal to a maximum width of the coded picture, and that a vertical position of the top left sample of the region plus a height of the region is less than or equal to a maximum height of the coded picture.
Clause 18B. The device of any of Clauses 15B-17B, wherein the PRI SEI message includes information regarding a reconstructed target picture, and wherein the one or more constraints include a requirement that a horizontal position of a top left sample of a region in the reconstructed target picture is in a range of 0 to a width of the reconstructed target picture minus 1, and that a vertical position of the top left sample of the region in the reconstructed target picture is in a range of 0 to a height of the reconstructed target picture minus 1.

It will be recognized that the constraints described in this disclosure may be used together in any combination.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A device for processing video data, the device comprising:
a memory configured to store video data; and
one or more processors implemented in circuitry and configured to:
obtain a bitstream that includes encoded video data, the bitstream further including an Object Mask Information (OMI) Supplemental Enhancement Information (SEI) message that provides object mask information associated with a primary layer in which the OMI SEI message is present; and
perform a bitstream conformance test on the bitstream that determines whether the bitstream complies with one or more constraints, wherein the one or more constraints include a requirement that, for each first OMI mask identifier in the OMI SEI message, there is no second OMI mask identifier in the OMI SEI message that is associated with a same object mask auxiliary layer as the first OMI mask identifier and that has a same value as the first OMI mask identifier.

2. The device of claim 1, wherein the one or more constraints include a requirement that there is at least one sample associated with an object mask having the first OMI mask identifier, wherein the at least one sample is at a first location in a cropped object mask picture in an auxiliary layer associated with the primary layer.

3. The device of claim 1, wherein the OMI SEI message includes a syntax element indicating whether object mask information of a specific object mask auxiliary layer is updated, and wherein the one or more constraints include a requirement that, when the OMI SEI message is parsed for a first time in a current coded layer video sequence (CLVS), a value of the syntax element shall be equal to 1.

4. The device of claim 3, wherein the syntax element is a first syntax element and the OMI SEI message includes a second syntax element specifying a number of object masks of the specific object mask auxiliary layer, and wherein the one or more constraints include a requirement that, when the first syntax element is parsed for the first time in the current CLVS, a value of the second syntax element shall not be equal to 0.

5. The device of claim 1, wherein the one or more processors are further configured to decode the encoded video data based on the bitstream passing the bitstream conformance test.

6. A device for processing video data, the device comprising:
a memory configured to store video data; and
one or more processors implemented in circuitry and configured to:
generate a bitstream that includes encoded video data such that the bitstream conforms to one or more constraints, the bitstream further including an Object Mask Information (OMI) Supplemental Enhancement Information (SEI) message that provides object mask information associated with a primary layer in which the OMI SEI message is present, wherein the one or more constraints include a requirement that, for each first OMI mask identifier in the OMI SEI message, there is no second OMI mask identifier in the OMI SEI message that is associated with a same object mask auxiliary layer as the first OMI mask identifier and that has a same value as the first OMI mask identifier.

7. The device of claim 6, wherein the one or more constraints include a requirement that there is at least one sample associated with an object mask having the first OMI mask identifier, wherein the at least one sample is at a first location in a cropped object mask picture in an auxiliary layer associated with the primary layer.

8. The device of claim 6, wherein the OMI SEI message includes a syntax element indicating whether object mask information of a specific object mask auxiliary layer is updated, and wherein the one or more constraints include a requirement that, when the OMI SEI message is parsed for a first time in a current coded layer video sequence (CLVS), a value of the syntax element shall be equal to 1.

9. The device of claim 8, wherein the syntax element is a first syntax element and the OMI SEI message includes a second syntax element specifying a number of object masks of the specific object mask auxiliary layer, and wherein the one or more constraints include a requirement that, when the first syntax element is parsed for the first time in the current CLVS, a value of the second syntax element shall not be equal to 0.

10. A device for processing video data, the device comprising:
a memory configured to store video data; and
one or more processors implemented in circuitry and configured to:
generate a bitstream that includes encoded video data such that the bitstream conforms to one or more constraints, the bitstream further including a Packed Region Information (PRI) Supplemental Enhancement Information (SEI) message that provides packed region information regarding rectangular regions packed within a coded picture of the video data, wherein the one or more constraints include a requirement that, for each first PRI region identifier in the PRI SEI message, there is no second PRI region identifier in the PRI SEI message that has a same value as the first PRI region identifier.

11. The device of claim 10, wherein the one or more constraints include a requirement that a horizontal position of a top left sample of a region is in a range of 0 to a width of the coded picture in luma samples minus 1, and that a vertical position of the top left sample of the region is in a range of 0 to a height of the coded picture in luma samples minus 1.

12. The device of claim 10, wherein the one or more constraints include a requirement that a horizontal position of a top left sample of a region plus a width of the region is less than or equal to a maximum width of the coded picture, and that a vertical position of the top left sample of the region plus a height of the region is less than or equal to a maximum height of the coded picture.

13. The device of claim 10, wherein the PRI SEI message includes information regarding a reconstructed target picture, and wherein the one or more constraints include a requirement that a horizontal position of a top left sample of a region in the reconstructed target picture is in a range of 0 to a width of the reconstructed target picture minus 1, and that a vertical position of the top left sample of the region in the reconstructed target picture is in a range of 0 to a height of the reconstructed target picture minus 1.
